(19) United States
(12) Patent Application Publication
(10) Pub. No.: US 2011/0067015 A1
(43) Pub. Date: Mar. 17, 2011

(54) PROGRAM PARALLELIZATION APPARATUS, PROGRAM PARALLELIZATION METHOD, AND PROGRAM PARALLELIZATION PROGRAM

(76) Inventors: Masamichi Takagi, Tokyo (JP); Junji Sakai, Tokyo (JP)

(21) Appl. No.: 12/866,219

(22) PCT Filed: Feb. 12, 2009
(86) PCT No.: PCT/JP2009/052309

§ 371 Date: Aug. 9, 2010

(30) Foreign Application Priority Data
Feb. 15, 2008 (JP) 2008-034614

(51) Int. Cl. G06F 9/45

(52) U.S. Cl. 717/149

(57) ABSTRACT

A program parallelization apparatus which generates a parallelized program of shorter parallel execution time is provided. The program parallelization apparatus inputs a sequential processing intermediate program and outputs a parallelized intermediate program. In the apparatus, a thread start time limitation analysis part analyzes an instruction-allocatable time based on a limitation on an instruction execution start time of each thread. A thread end time limitation analysis part analyzes an instruction-allocatable time based on a limitation on an instruction execution end time of each thread. An occupancy status analysis part analyzes a time not occupied by already-scheduled instructions. A dependence delay analysis part analyzes an instruction-allocatable time based on a delay resulting from dependence between instructions. A schedule candidate instruction select part selects a next instruction to schedule. An instruction arrangement part allocates a processor and time to execute to an instruction.

### TECHNICAL FIELD

The present invention relates to a program parallelization apparatus, a program parallelization method, and a program parallelization program which generate a parallelized program intended for multithreaded parallel processors from a sequential processing program.

### BACKGROUND ART

Among the techniques for processing a single sequential processing program in parallel in a parallel processor system is a multithread execution method of dividing a program into instruction flows called threads and executing the threads with a plurality of processors in parallel (for example, see PTL 1 to 5 and NPL 1 and 2). The parallel processors that perform multithread execution will be referred to as “multithreaded parallel processors.” Hereinafter, the multithread execution method and multithreaded parallel processors according to the relevant technologies will be described.

With the multithread execution method and multithreaded parallel processors, creating a new thread on another processor is typically referred to as “forking a thread.” In such a case, the thread that makes the forking operation is referred to as a “parent thread,” and the new thread created a “child thread.” The program position where to fork a thread is referred to as a “fork source address” or “fork source point.” The program position at the top of the child thread is referred to as a “fork destination address,” “fork destination point,” or “the start point of the child thread.”

In PTL 1 to 4 and NPL 1 and 2, the forking of a thread is instructed by inserting a fork instruction to the fork source point. A fork instruction designates the fork destination address. The execution of the fork instruction creates a child thread starting at the fork destination address on another processor, whereby the child thread starts its execution. The program position where to end thread processing is referred to as a “term point.” Each processor ends processing a thread at its term point.

FIG. 30 provides an overview of the processing of a multithread execution method with multithreaded parallel processors.

FIG. 30A shows a single sequential processing program which is divided into three threads A, B, and C. When a single processor processes the program, as shown in FIG. 30B, the single processor PE processes the threads A, B, and C in order.

Now, according to the multithread execution methods with multithreaded parallel processors of PTL 1 to 4 and NPL 1 and 2, one of the processors, PE1, executes the thread A as shown in FIG. 30C. While the processor PE1 is executing the thread A, the fork instruction embedded in the thread A creates the thread B on another processor PE2, so that the processor PE2 executes the thread B. Next, the processor PE2 creates the thread C on yet another processor PE3 due to the fork instruction embedded in the thread B. Next, the processors PE1 and PE2 end processing of the threads at the term points immediately before the start points of the threads B and C, respectively. The processor PE3 then executes the last instruction in the thread C, and executes a next instruction (typically a system call instruction). Consequently, a plurality of processors concurrently execute the threads in parallel for improved performance as compared to the sequential processing.

For example, given three processors, a processor 1 executes thread 1, a processor 2 executes thread 2, a processor 3 executes thread 3, the processor 1 executes thread 4, the processor 2 executes thread 5, and the processor 3 executes thread 6. The processors are repeatedly used in this way.

FIG. 31 shows the example. In FIG. 31, the circles represent instructions. F1 to F5 are fork instructions. Given three processors. The first thread which includes instructions F1 and I1 to I3 is executed by a processor 1. Instructed by the fork instruction F1, the second thread including instructions F2 and I4 to I6 is executed by a processor 2. Instructed by the fork instruction F2, the third thread including instructions F3 and I7 to I9 is executed by a processor 3. Instructed by the fork instruction F3, the fourth thread including instructions F4 and I10 to I12 is now executed by the processor 1. Instructed by the fork instruction F4, the fifth thread including instructions F5 and I13 to I15 is then executed by the processor 2. When viewed from the program, there appear to be an infinite number of processors. The Nth processor among an apparently infinite number of processors is used by the Nth thread. In the following description, the numbers of the respective processors which appear to be infinite in number will thus be expressed by using the thread numbers instead.

In another possible multithread execution method, as shown in FIG. 30D, the processor PE1 executing the thread A forks a plurality of times, thereby creating the threads B and C on the processors PE2 and PE3, respectively. In contrast to such a model of FIG. 30D, the multithread execution method shown in FIG. 30C under the restriction that a thread may create a valid child thread only once in life will be referred to as “single fork model.” The single fork model can significantly simplify thread management, so that the thread management part can be implemented by hardware in a practical hardware scale. Since the number of other processors for each individual processor to create a child thread on is limited to one, adjoining processors can be annually connected in one direction to configure a parallel processor system that is capable of multithread execution.

Now, if there is no processor available for a fork instruction to create a child thread on, a typical method to deal with it is that the processor that is executing the parent thread waits the execution of the fork instruction for the occurrence of a processor available for the creation of the child thread. Another method is to disable the fork instruction and continue executing the instructions subsequent to the fork instruction before executing a group of instructions of the child thread by itself as described in PTL 4.

In order for a parent thread to create a child thread and make the child thread perform predetermined processing, at least the values of registers that are needed in the child thread among those in a register file at the fork point of the parent thread need to be passed from the parent thread to the child thread.

To reduce the cost of such data delivery between threads, PTL 2 and NPL 1 provide a hardware mechanism for register value inheritance at the time of thread creation. By the mechanism, the entire contents of the register file of the parent thread are duplicated for the child thread at the time of thread creation. After the creation of the child thread, the register values of the parent thread and child thread are independently alterable, with no register-based data delivery between the threads.

NPL 2 provides a hardware mechanism for register value inheritance at the time of thread creation. With the mechanism, register values needed are transferred between threads upon the creation of the child thread and after the creation of the child thread. In other words, according to the method, register values can be transferred from an instruction to another, whereas the transfer is performed only in directions where the thread number remains unchanged or increases.

For another technology relevant to the data delivery between threads, a parallel processor system has been proposed which includes a mechanism for transferring individual register values in units of registers by instructions.

Multithread execution methods are based on the parallel execution of preceding threads that are determined to be executed. With actual programs, however, it is often not possible to obtain a sufficient number of execution-determined threads. Dynamically-determined dependence, compiler's analytical limits, and other factors can sometimes suppress the parallelization rate, failing to provide desired performance.

In PTL 1, control speculation is thus introduced to support speculative execution of threads by hardware. With control speculation, threads that are likely to be executed are speculatively executed before determined to be executed. The threads under speculation are tentatively executed within the extent where the execution can be cancelled in terms of hardware. The state where a child thread is under tentative execution is referred to as a “tentative execution state.” A parent thread whose child thread is in the tentative execution state is referred to as being in a “tentative thread-created state.” In a child thread of the tentative execution state, a write to a shared memory or cache memory is suppressed, and the write is performed to an additional temporary buffer.

If a speculation is determined to be correct, a speculation success notification is issued from the parent thread to the child thread. The child thread reflects the contents of the temporary buffer upon the shared memory and cache memory, entering a normal state where the temporary buffer is not used. The parent thread shifts from the tentative thread-created state to a thread-created state. On the other hand, if the speculation is determined to be a failure, the parent thread executes a thread abort instruction to cancel the execution of the child thread. The parent thread shifts from the tentative thread-created state to a thread-uncreated state, and becomes capable of creating a child thread again. That is, while in the single fork model, the thread creation is limited to only once, the thread can be speculatively forked and if the speculation fails, forking can be performed again. Even in such a case, the number of valid child threads is one at most.

The threads implement the multithread execution of the single fork model such that the threads create a valid child thread only once in their life. For example, in NPL 1 and the like, a limitation is imposed at the compiling stage of generating a parallelized program from a sequential processing program, so as to generate instruction code where all the threads validly fork only once. In other words, the single fork limitation on the parallelized program is statistically ensured. In contrast, in PTL 3, a parent thread contains a plurality of fork instructions, from which a fork instruction that creates a valid child thread is selected when the parent thread is running. The single fork limitation is thereby ensured at the time of program execution.

Next, description will be given of relevant technologies for generating a parallel program that is intended for parallel processors for multithread execution.

Referring to FIG. 32, a program parallelization apparatus according to a relevant technology (for example, PTL 6) inputs a source file 501, and a syntactic analysis part 500 analyzes the structure of the source file 501. In the apparatus, an execution time acquisition function insert part 504 then inserts functions for measuring loop iterations for execution time. In the apparatus, a parallelization part 506 parallelizes the loop iterations. In the apparatus, a code generation part 507 outputs execution time acquiring object code 510 in which the functions for measuring loop iterations for execution time are inserted. The object code 509 is then executed to create an execution time information file 508. In the apparatus, after the analysis of the syntactic analysis part 500 again, an execution time input part 505 inputs the execution time of the loop iterations, and the code generation part 507 generates and outputs object code 509 for parallel execution. According to the apparatus, the execution time of each loop iteration is thus measured in advance. When the loop iterations are distributed between a plurality of processors for parallelization, the iterations are allocated to equalize the processor loads. The apparatus can thereby reduce the parallel execution time.

Referring to FIG. 33, a program parallelization apparatus according to another relevant technology (for example, PTL 7) inputs a source program 602, and a section arrangement unit 631 sorts the units of parallel processing of the program, or sections, in descending order of execution time. In the apparatus, a thread association unit 641 generates object code for performing the processing of executing sections in threads, with the sorted order as the order of priority. In the apparatus, when a thread starts executing a section, an assignment indication unit 642 generates object code for performing the processing of indicating that the section starts its execution. In the apparatus, when a thread completes executing a section, a next section execution unit 643 generates object code for performing the processing of executing a section that has not started its execution yet. Consequently, according to the apparatus, processes that are capable of parallel execution are pooled, and the processors fetch and process the processes in sequence, thereby equalizing the processor loads. In such a way, the apparatus can also reduce the parallel execution time.

### CITATION LIST

### Patent Literature

{PTL 1} JP-A-10-27108
{PTL 2} JP-A-10-78880
{PTL 3} JP-A-2003-029985
{PTL 4} JP-A-2003-029984
{PTL 5} JP-A-2001-282549
{PTL 6} JP-A-2004-152204
{PTL 7} JP-A-2004-094581

### Non-Patent Literature

{NPL 1} Sunao Torii et al., “Proposal of on chip multiprocessor-oriented control parallel architecture MUSCAT,” Parallel Processing Symposium JSPP97 Articles, Information Processing Society of Japan, pp. 229-236, May 1997
{NPL 2} Taku Ohsawa, Masamichi Takagi, Shoji Kawahara, Satoshi Matsushita: Pinot: Speculative Multi-threading Processor Architecture Exploiting Parallelism Over a Wide Range of Granularities. In Proceedings of 38th MICRO, pages 81-92, 2005.
{NPL 3} Thomas L. Adam, K. M. Chandy, J. R. Dickson, “A comparison of list schedules for parallel processing systems,” Communications of the ACM, Volume 17, Issue 12, pp. 685-690, December 1974.
{NPL 4} H. Kasahara, S. Narita, “Practical Multiprocessor Scheduling Algorithms for Efficient Parallel Processing,” IEEE Trans. on Computers, Vol. C-33, No. 11, pp. 1023-1029, November 1984.
{NPL 5} Yu-Kwong Kwok and Ishfaq Ahmad, “Static Scheduling Algorithms for Allocating Directed Task Graphs to Multiprocessors,” ACM Computing Surveys, Vol. 31, No. 4, December 1999.

### SUMMARY OF INVENTION

### Technical Problem

The foregoing relevant technologies have had the problem that it is not possible to provide a parallelized program of shorter parallel execution time. The problem will be described below.

The program parallelization apparatuses according to the foregoing relevant technologies (for example, NPL 3 to 5) allocate instructions to slots in a two-dimensional space which is expressed by <thread number,cycle number>, based on graphs that show data dependence, control dependence, and the dependence of instruction order. Here, the instructions are prioritized, and are allocated to unoccupied slots <thread number,execution time> of the earliest execution times one by one in descending order of priority. It has sometimes been the case that the numbers of instructions assigned to some threads become uneven, which produces cycles where no instruction is executed by the processors with an increase in the parallel execution time. FIG. 6 shows an example thereof.

In the example, as shown in FIG. 6A, so many instructions are allocated to thread 1 that the processor 2 undergoes cycles where no instruction is executed. The parallel execution time is thus longer than when equal numbers of instructions are allocated as shown in FIG. 6B.

The program parallelization apparatuses according to other relevant technologies mentioned above (for example, PTL 6 and 7) do not have uniform intervals between execution start times even if equal numbers of instructions are assigned to respective threads. This can produce cycles where no instruction is executed by the processors with an increase in the execution time. FIG. 7 shows an example thereof.

In the example, as shown in FIG. 7A, the processor 1 undergoes a cycle where no instruction is executed since the sequence of instructions allocated to processor 2 has a late start time. The parallel execution time is thus longer than when instructions are allocated with equal intervals between execution start times as shown in FIG. 7B.

As described above, the program parallelization apparatuses of the relevant technologies have sometimes had longer parallel execution time due to uneven numbers of instructions assigned to some processors or nonuniform intervals between instruction execution start times.

The present invention has been proposed in view of the foregoing circumstances. It is an object of the present invention to provide a program parallelization apparatus and method which can generate a parallelized program of shorter parallel execution time by scheduling instructions so as not to make the numbers of instructions in respective threads uneven and so as to make the intervals between the instruction execution start times of the respective threads uniform.

### Solution to Problem

To achieve the foregoing object, a program parallelization apparatus according to the present invention is a program parallelization apparatus for inputting a sequential processing intermediate program and outputting a parallelized intermediate program, the apparatus including: a thread start time limitation analysis part that analyzes an instruction-allocatable time based on a limitation on an instruction execution start time of each thread; a thread end time limitation analysis part that analyzes an instruction-allocatable time based on a limitation on an instruction execution end time of each thread; an occupancy status analysis part that analyzes a time not occupied by an already-scheduled instruction; a dependence delay analysis part that analyzes an instruction-allocatable time based on a delay resulting from dependence between instructions; a schedule candidate instruction select part that selects a next instruction to schedule; and an instruction arrangement part that allocates a processor and time to execute to an instruction.

A program parallelization method according to the present invention is a program parallelization method for inputting a sequential processing intermediate program and outputting a parallelized intermediate program intended for multithreaded parallel processors, the method including the steps of selecting a limitation from a set of limitations on instruction execution start and end times of each thread; for an instruction, analyzing an instruction-allocatable time based on the limitation on the instruction execution start time of each thread; for an instruction, analyzing an instruction-allocatable time based on the limitation on the instruction execution end time of each thread; analyzing a time not occupied by an already-scheduled instruction processor by processor; analyzing a delay resulting from dependence between instructions; selecting a next instruction to schedule; and allocating a processor and time to execute to an instruction.

A program parallelization program according to the present invention is one for use with a computer that constitutes a program parallelization apparatus for inputting a sequential processing intermediate program and outputting a parallelized intermediate program intended for multithreaded parallel processors, the program parallelization program making the computer function as: an instruction execution start and end time limitation select unit that selects a limitation from a set of limitations on an interval between instruction execution start times of respective threads and the number of instructions to execute; a thread start time limitation analysis unit that analyzes an instruction-allocatable time based on the limitation on the instruction execution start time of each thread; a thread end time limitation analysis unit that estimates an instruction to be executed at a latest time in a sequence of dependent instructions to which a certain instruction belongs and an execution time of the instruction based on the limitation on the number of instructions to execute in each thread; an occupancy status analysis unit that analyzes a time not occupied by an already-scheduled instruction processor by processor; a dependence delay analysis part that analyzes an instruction-allocatable time based on a delay resulting from dependence between instructions; a schedule candidate instruction select unit that selects a next instruction to schedule; and an instruction arrangement unit that allocates a processor and time to execute to an instruction.

### ADVANTAGEOUS EFFECTS OF INVENTION

According to the present invention, it is possible to generate a parallelized program of shorter parallel execution time by scheduling instructions so as to reduce idle time where no instruction is executed in each thread, so as not to make the numbers of instructions in respective threads uneven, and so as to make the intervals between the instruction execution start times of the respective threads uniform.

### BRIEF DESCRIPTION OF DRAWINGS

FIG. 1 A block diagram of a program parallelization apparatus according to a first example of the present invention.

FIG. 2 A flowchart showing an example of processing of a thread start and end time limitation scheduling part in the program parallelization apparatus according to the first example.

FIG. 3 A flowchart that follows FIG. 2, showing an example of processing of the thread start and end time limitation scheduling part in the program parallelization apparatus according to the first example.

FIG. 4 A flowchart showing an example of processing of the thread start and end time limitation scheduling part in the program parallelization apparatus according to the first example.

FIG. 5 A flowchart that follows FIG. 4, showing an example of processing of the thread start and end time limitation scheduling part in the program parallelization apparatus according to the first example.

FIGS. 6A and 6B are diagrams showing a problem of relevant technologies.

FIGS. 7A and 7B are diagrams showing a problem of other relevant technologies.

FIGS. 8A and 8B are diagrams showing examples of limitations on the instruction execution start and end times of the threads such that a difference between the start time and end time is constant in all the threads and the start time increases with the thread number by a constant increment.

FIGS. 9A and 9B are diagrams showing how to predict a thread number and time to execute each instruction belonging to a longest sequence of dependent instructions.

FIG. 10 A diagram showing an example of an instruction dependence graph for explaining a longest sequence of dependent instructions starting with a certain instruction.

FIG. 11 A diagram showing an example of a limitation on the instruction execution start time such that the start time of each thread increases with the thread number by a constant increment of three.

FIGS. 12A and 12B are diagrams showing how to select instruction-allocatable thread numbers and times in consideration of a limitation on the start and end times of each thread.

FIGS. 13A and 13B are diagrams showing how to predict the execution time of a sequence of instructions in consideration of a limitation on the start and end times of each thread.

FIGS. 14A and 14B are diagrams showing dependence graphs of a program that is used when describing a concrete example of the processing of the thread start and end time limitation scheduling part in the program parallelization apparatus according the first example.

FIG. 15 A diagram showing a concrete example of a limitation on the instruction execution start and end times of each thread and fork instructions according to the first example.

FIG. 16 A diagram showing a concrete example of tentative allocation of a sequence of instructions in the first example.

FIG. 17 A diagram showing a concrete example of tentative allocation of a sequence of instructions in the first example.

FIG. 18 A diagram showing a concrete example of tentative allocation of a sequence of instructions in the first example.

FIG. 19 A diagram showing a concrete example of an intermediate result of instruction scheduling in the first example.

FIG. 20 A diagram showing a concrete example of an intermediate state of instruction scheduling in the first example.

FIG. 21 A diagram showing a concrete example of tentative allocation of a sequence of instructions in the first example.

FIG. 22 A diagram showing a concrete example of tentative allocation of a sequence of instructions in the first example.

FIG. 23 A diagram showing a concrete example of the result of instruction scheduling in the first example.

FIG. 24 A diagram showing a concrete example of tentative allocation of a sequence of instructions in the first example.

FIG. 25 A diagram showing a concrete example of tentative allocation of a sequence of instructions in the first example.

FIG. 26 A diagram showing a concrete example of tentative allocation of a sequence of instructions in the first example.

FIG. 27 A block diagram of a program parallelization apparatus according to a second example of the present invention.

FIG. 28 A flowchart showing an example of processing of the thread start and end time limitation scheduling part in the program parallelization apparatus according to the second example.

FIG. 29 A block diagram of a program parallelization apparatus according to a third example of the present invention.

FIGS. 30A to 30D are diagrams for summarizing a multithread execution method.

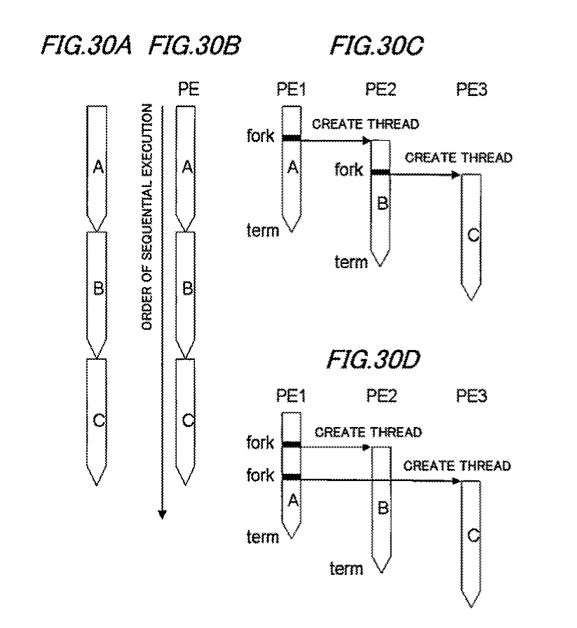

FIG. 31 A diagram for explaining the order of use of processors in threads according to the multithread execution method.

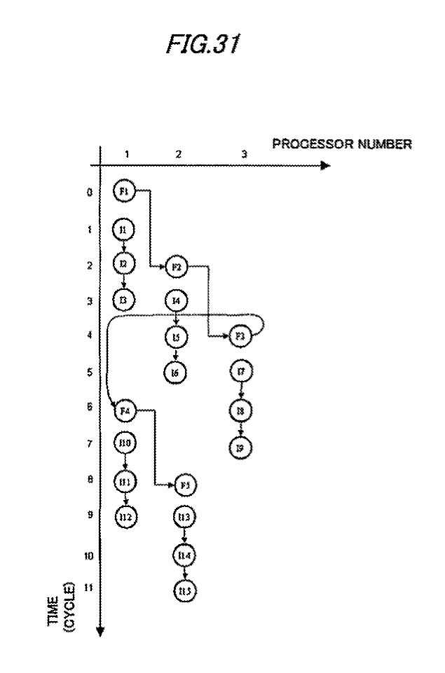

FIG. 32 A block diagram showing an example of the configuration of a program parallelization apparatus according to a relevant technology.

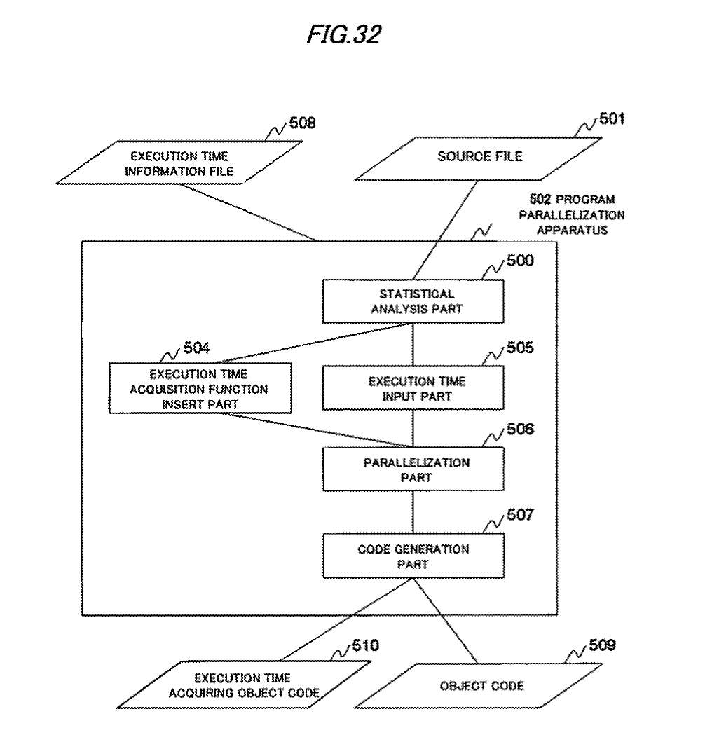

FIG. 33 A block diagram showing an example of the configuration of a program parallelization apparatus according to another relevant technology.

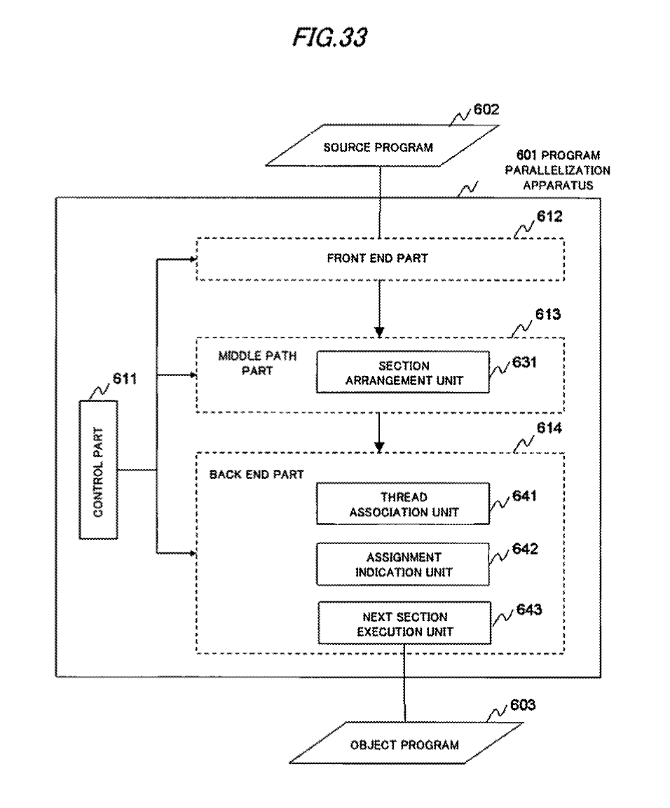

### REFERENCE SIGNS LIST

100, 100A, 100B: program parallelization apparatus
101: sequential processing program
101M: storing part
102: storage device
103: parallelized program
103M: storing part
104: storage device
107, 107A, 107B: processing device
108, 108A: thread start and end time limitation scheduling part
110: control flow analysis part
140: schedule area formation part
150: register data flow analysis part
170: inter-instruction memory data flow analysis part
180: instruction execution start and end time limitation select part
190: schedule candidate instruction select part
200: instruction arrangement part
210: fork instruction insert part
220: thread start time limitation analysis part
230: thread end time limitation analysis part
240: occupancy status analysis part
250: dependence delay analysis part
260: best schedule determination part
270: parallel execution time measurement part
280: register allocation part
290: program output part
301: storage device
302: storage device
303: storage device
304: storage device
305: storage device
306: storage device
310: profile data
310M: storing part
320: sequential processing intermediate program
320M: storing part
330: inter-instruction dependence information
330M: storing part
340: limitation on instruction execution start and end times
340M: storing part
350: parallelized intermediate program
350M: storing part
360: set of limitations on instruction execution start and end times
360M: storing part

### DESCRIPTION OF EMBODIMENTS

Now, exemplary embodiments of the program parallelization apparatus, the program parallelization method, and the program parallelization program according to the present invention will be described in detail with reference to the drawings.

In the exemplary embodiments of the present invention, each thread is “scheduled” with a limitation imposed on instruction execution start and end times. “Scheduling (instruction scheduling)” refers to determining the execution thread number and execution time of each instruction. The scheduling is performed so as to reduce parallel execution time. A processor-allocatable thread number and time are analyzed that meet the limitation on the instruction execution start and end times of each thread. A thread number and time to execute each instruction belonging to a “longest sequence of dependent instructions” are predicted. The “longest sequence of dependent instructions” refers to a sequence of instructions that has the latest execution end time among dependence-based sequences of instructions on an instruction dependence graph (to be described later). The execution time of the longest sequence of dependent instructions is predicted in consideration of the limitation on the instruction execution start and end times of each thread.

Hereinafter, each of the exemplary embodiments of the present invention will be described.

### First Exemplary Embodiment

A program parallelization apparatus according to a first exemplary embodiment inputs a sequential processing intermediate program and outputs a parallelized intermediate program. The program parallelization apparatus includes an instruction execution start and end time limitation select part, a thread start time limitation analysis part, a thread end time limitation analysis part, an occupancy status analysis part, a dependence delay analysis part, a schedule candidate instruction select part, and an instruction arrangement part.

The instruction execution start and end time limitation select part selects a limitation from a set of limitations on the instruction execution start and end times of each thread.

The thread start time limitation analysis part analyzes an instruction-allocatable time based on the limitation on the instruction execution start time of each thread.

The thread end time limitation analysis part analyzes an instruction-allocatable time based on the limitation on the instruction execution end time of each thread.

The occupancy status analysis part analyzes a time not occupied by already-scheduled instructions processor by processor.

The dependence delay analysis part analyzes an instruction-allocatable time based on a delay resulting from dependence between instructions.

The schedule candidate instruction select part selects the next instruction to schedule.

The instruction arrangement part allocates a processor and time to execute to an instruction.

### Second Exemplary Embodiment

A program parallelization apparatus according to a second exemplary embodiment inputs a sequential processing intermediate program and outputs a parallelized intermediate program. The program parallelization apparatus includes an instruction execution start and end time limitation select part, a thread start time limitation analysis part, a thread end time limitation analysis part, an occupancy status analysis part, a dependence delay analysis part, a schedule candidate instruction select part, a parallel execution time measurement part, and a best schedule determination part.

The instruction execution start and end time limitation select part selects a limitation from a set of limitations on the instruction execution start and end times of each thread.

The thread start time limitation analysis part analyzes an instruction-allocatable time based on the limitation on the instruction execution start time of each thread.

The thread end time limitation analysis part analyzes an instruction-allocatable time based on the limitation on the instruction execution end time of each thread.

The occupancy status analysis part analyzes a time not occupied by already-scheduled instructions processor by processor.

The dependence delay analysis part analyzes an instruction-allocatable time based on a delay resulting from dependence between instructions.

The schedule candidate instruction select part selects the next instruction to schedule. The instruction arrangement part allocates a processor and time to execute to an instruction.

The parallel execution time measurement part measures or estimates parallel execution time in response to a result of scheduling.

The best schedule determination part changes the limitation and repeats scheduling to determine a best schedule.

### Third Exemplary Embodiment

A program parallelization apparatus according to a third exemplary embodiment inputs a sequential processing program and outputs a parallelized program intended for multithreaded parallel processors. The program parallelization apparatus includes a control flow analysis part, a schedule area formation part, a register data flow analysis part, an inter-instruction memory data flow analysis part, an instruction execution start and end time limitation select part, a thread start time limitation analysis part, a thread end time limitation analysis part, an occupancy status analysis part, a dependence delay analysis part, an instruction arrangement part, a parallel execution time measurement part, a best schedule determination part, a register allocation part, and a program output part.

The control flow analysis part analyzes the control flow of the input sequential processing program.

The schedule area formation part refers to the result of analysis of the control flow by the control flow analysis part and determines the area to be scheduled.

The register data flow analysis part refers to the determination of the schedule area made by the schedule area formation part and analyzes the data flow of a register.

The inter-instruction memory data flow analysis part analyzes the dependence between an instruction to make a read or write to an address and an instruction to make a read or write from the address.

The instruction execution start and end time limitation select part selects a limitation from a set of limitations on the instruction execution start and end times of each thread.

The thread start time limitation analysis part analyzes an instruction-allocatable time based on the limitation on the instruction execution start time of each thread.

The thread end time limitation analysis part analyzes an instruction-allocatable time based on the limitation on the instruction execution end time of each thread.

The occupancy status analysis part analyzes a time not occupied by already-scheduled instructions processor by processor.

The dependence delay analysis part analyzes an instruction-allocatable time based on a delay resulting from dependence between instructions.

The instruction arrangement part allocates a processor and time to execute to a schedule candidate instruction selection part that selects a next instruction to schedule, and to an instruction.

The parallel execution time measurement part measures or estimates parallel execution time in response to a result of scheduling.

The best schedule determination part changes the limitation and repeats scheduling to determine a best schedule.

The register allocation part refers to the result of determination of the best schedule and performs register allocation.

The program output part refers to the result of the register allocation, and generates and outputs a parallelized program.

### Fourth Exemplary Embodiment

In a fourth exemplary embodiment, the schedule candidate instruction select part analyzes a thread number and time to execute each of instructions that belong to a sequence of dependent instructions starting with a candidate instruction to schedule.

### Fifth Exemplary Embodiment

In a fifth exemplary embodiment, the instruction execution start and end time limitation select part includes in the set of limitations only limitations on the execution start and end times such that a difference between the start time and end time is constant in all threads and the start time increases with the thread number by a constant increment.

### Sixth Exemplary Embodiment

A sixth exemplary embodiment inputs a sequential processing intermediate program and outputs a parallelized intermediate program intended for multithreaded parallel processors. This program parallelization method includes the following steps.

A1) Select a limitation from a set of limitations on the instruction execution start and end times of each thread.
A2) For an instruction, analyze an instruction-allocatable time based on the limitation on the instruction execution start time of each thread.
A3) For an instruction, analyze an instruction-allocatable time based on the limitation on the instruction execution end time of each thread.
A4) Analyze a time not occupied by already-scheduled instructions processor by processor.
A5) Allocate a processor and time to execute to a step of selecting a next instruction to schedule, and to an instruction.

### Seventh Exemplary Embodiment

A program parallelization method according to a seventh exemplary embodiment inputs a sequential processing intermediate program and outputs a parallelized intermediate program. The program parallelization method includes the following steps.

B1) Select a limitation from a set of limitations on the instruction execution start and end times of each thread.
B2) Analyze an instruction-allocatable time based on the limitation on the instruction execution start time of each thread.
B3) Analyze an instruction-allocatable time based on the limitation on the instruction execution end time of each thread.
B4) Analyze a time not occupied by already-scheduled instructions processor by processor.
B5) Allocate a processor and time to execute to a step of selecting a next instruction to schedule, and to an instruction.
B6) Change a step of measuring or estimating parallel execution time in response to a result of scheduling and the limitation and repeat scheduling to determine a best schedule.

### Eighth Exemplary Embodiment

A program parallelization method according to an eighth exemplary embodiment inputs a sequential processing program and outputs a parallelized program intended for multithreaded parallel processors. The program parallelization method includes the following steps.

C1) Analyze the control flow of the input sequential processing program.
C2) Refer to the result of analysis of the control flow and determine the area to be scheduled.
C3) Refer to the determination of the schedule area and analyze the data flow of a register.
C4) Analyze the dependence between an instruction to make a read or write to an address and an instruction to make a read or write from the address.
C5) Select a limitation from a set of limitations on the instruction execution start and end times of each thread.
C6) Analyze an instruction-allocatable time based on the limitation on the instruction execution start time of each thread.
C7) Analyze an instruction-allocatable time based on the limitation on the instruction execution end time of each thread.
C8) Analyze a time not occupied by already-scheduled instructions processor by processor.
C9) Allocate a processor and time to execute to a step of selecting a next instruction to schedule, and to an instruction.
C10) Measure or estimate parallel execution time in response to a result of scheduling.
C11) Change the limitation and repeat scheduling to determine a best schedule.
C12) Refer to the result of determination of the best schedule and perform register allocation.
C13) Refer to the result of the register allocation, and generate and output the parallelized program.

### Ninth Exemplary Embodiment

A program parallelization method according to a ninth exemplary embodiment includes the following steps.

a) An instruction execution start and end time limitation select part selects an unselected limitation SH from a set of limitations on the instruction execution start and end times of each thread.
b) A thread start time limitation analysis part, occupancy status analysis part, thread end time limitation analysis part, schedule candidate instruction select part, and instruction arrangement part perform instruction scheduling according to the limitation SH, and obtain the result of scheduling SC.
c) A parallel execution time measurement part measures or estimates parallel execution time of the result of scheduling SC.
d) A best schedule determination part stores the result of scheduling SC as a shortest schedule if it is shorter than shortest parallel execution time stored.
e) The best schedule determination part determines whether all the limitations are selected.
f) The best schedule determination part outputs the shortest schedule as the final schedule.

### Tenth Exemplary Embodiment

In a tenth exemplary embodiment, the step b) includes the following steps.

b-1) The instruction arrangement part calculates HT(I) for each instruction I, and stores the instruction that gives the value.
b-2) The instruction arrangement part registers an instruction on which no instruction is dependent into a set RS.
b-3) The instruction arrangement part deselects all instructions in the set RS.
b-4) The schedule candidate instruction select part selects an unselected instruction belonging to the set RS as an instruction RI.
b-5) The schedule candidate instruction select part determines a highest thread number LF among those of already-scheduled instructions on which the instruction RI is dependent, determines a lowest thread number RM that is higher than the thread number LF and to which no instruction is currently allocated, and sets a thread number TN to LF.
b-6) For the thread numbered TN, the thread start time limitation analysis part analyzes a minimum value of the instruction-allocatable time based on the limitation on the instruction execution start time of each thread, and assumes the time as ER1.
b-7) For the thread numbered TN, the occupancy status analysis part analyzes times where are not occupied by already-scheduled instructions, and assumes a set of the times as ER2.
b-8) The dependence delay analysis part determines a time of arrival ER3 of data from an instruction that delivers data to the thread numbered TN the latest among already-scheduled instructions on which the instruction RI is dependent.
b-9) For the thread numbered TN, the thread end time limitation analysis part analyzes a maximum value of the instruction-allocatable time based on the limitation on the instruction execution end time, and assumes the value as ER4.
b-10) The schedule candidate instruction select part determines whether there is a minimum element of the set ER2 that is at or above the time ER1, at or below the time ER4, and at or above the time ER3.
b-11) The schedule candidate instruction select part advances the thread number TN by one.
b-12) The schedule candidate instruction select part assumes the time as ER5 if exists.
b-13) The schedule candidate instruction select part estimates the execution time of a last instruction TI in a longest sequence of dependent instructions starting with the instruction RI based on the limitation on the execution start and end times of each thread, on the assumption that the instruction RI is tentatively allocated to the thread number TN and the time ER5.
b-14) The schedule candidate instruction select part stores the thread number and time of the instruction RI with which the instruction TI is executed at the earliest time across the thread number TN, and the estimated predicted time of the instruction TI into the instruction RI.
b-15) The schedule candidate instruction select part determines whether the thread number TN reaches RM.
b-16) The schedule candidate instruction select part advances the thread number TN by one.
b-17) The schedule candidate instruction select part determines whether all the instructions in the set RS are selected.
b-18) The instruction arrangement part assumes an instruction that provides the maximum predicted time of the instruction TI stored at the step b-14 as a scheduling target CD, and allocates the scheduling target CD to the thread number stored at the step b-14 and the time stored at the step b-14.
b-19) The instruction arrangement part removes the instruction CD from the set RS, checks the set RS for an instruction that is dependent on the instruction CD, assumes that the dependence of the instruction on the instruction CD is resolved, and if the instruction has no other instruction to depend on, registers the instruction into the set RS.
b-20) The instruction arrangement part determines whether all the instructions are scheduled.
b-21) The instruction arrangement part outputs the result of scheduling.

### Eleventh Exemplary Embodiment

In an eleventh exemplary embodiment, the step b-9) includes the following steps.

b-9-1) The schedule candidate instruction select part determines a longest sequence of instructions TS starting with the instruction RI on a dependence graph, and expresses TS as TL[0], TL[1], TL[2], . . . , where TL[0] is RI.
b-9-2) The schedule candidate instruction select part sets a variable V2 to 1.
b-9-3) The schedule candidate instruction select part determines a highest thread number LF2 among those of already-scheduled or tentatively-allocated instructions on which the instruction TL[V2] is dependent, determines a lowest thread number RM2 that is higher than the thread number LF2 and to which no instruction is currently allocated, and substitutes LF2 into a variable CU.
b-9-4) For a thread numbered CU, the thread start time limitation analysis part analyzes a minimum value of the instruction-allocatable time based on the limitation on the instruction execution start time of each thread, and assumes the time as ER11.
b-9-5) For the thread numbered CU, the occupancy status analysis part analyzes times that are not occupied by already-scheduled or tentatively-allocated instructions, and assumes a set of the times as ER12.
b-9-6) The dependence delay analysis part checks already-scheduled or tentatively-allocated instructions on which the instruction TL[V2] is dependent for transmission of data to TL[V2], checks the times of arrival of the data from such instructions to the thread numbered CU, and assumes a maximum value thereof as ER13.
b-9-7) For the thread numbered CU, the thread end time limitation analysis part analyzes a maximum value of the instruction-allocatable time based on the limitation on the instruction execution end time, and assumes the value as ER14.
b-9-8) The schedule candidate instruction select part determines whether there is a minimum element of the set ER12 that is at or above the time ER11, at or below the time ER14, and at or above the time ER13.
b-9-9) The schedule candidate instruction select part advances the thread number CU by one.
b-9-10) The schedule candidate instruction select part assumes the time as ER15 if exists.
b-9-11) The schedule candidate instruction select part stores the minimum value of the time ER15 of the instruction TL[V2] across the thread number CU, and if the minimum value is updated, stores CU as well.
b-9-12) The schedule candidate instruction select part determines whether CU reaches RM2.
b-9-13) The schedule candidate instruction select part increases the thread number CU by one.
b-9-14) The schedule candidate instruction select part tentatively allocates TL[V2] to the thread number and time stored at the step b-9-11.
b-9-15) The schedule candidate instruction select part determines whether all the instructions in TS are tentatively allocated.
b-9-16) The schedule candidate instruction select part increases the variable V2 by one.
b-9-17) The schedule candidate instruction select part detaches all the tentative allocations, and outputs the thread number and time to which TL[V2] is tentatively allocated.

### Twelfth Exemplary Embodiment

In a twelfth exemplary embodiment, the step of selecting a next instruction to schedule includes analyzing a thread number and time to execute each of instructions that belong to a longest sequence of dependent instructions starting with a candidate instruction to schedule.

### Thirteenth Exemplary Embodiment

For a thirteenth exemplary embodiment, in the step of selecting a limitation from the set of limitations on the instruction execution start and end times of each thread, the set of limitations includes only limitations on the execution start and end times such that a difference between the start time and end time is constant in all threads and the start time increases with the thread number by a constant increment.

### Fourteenth Exemplary Embodiment

A program parallelization program according to a fourteenth exemplary embodiment is one for use with a computer that constitutes a program parallelization apparatus for inputting a sequential processing intermediate program and outputting a parallelized intermediate program intended for multithreaded parallel processors, the program parallelization program making the computer function as an instruction execution start and end time limitation select unit, a thread start time limitation analysis unit, a thread end time limitation analysis unit, an occupancy status analysis unit, a schedule candidate instruction select unit, and an instruction arrangement unit.

The instruction execution start and end time limitation select unit selects a limitation from a set of limitations on the instruction execution start and end times of each thread.

The thread start time limitation analysis unit analyzes an instruction-allocatable time based on the limitation on the instruction execution start time of each thread.

The thread end time limitation analysis unit analyzes an instruction-allocatable time based on the limitation on the instruction execution end time of each thread.

The occupancy status analysis unit analyzes a time not occupied by already-scheduled instructions processor by processor.

The schedule candidate instruction select unit selects a next instruction to schedule.

The instruction arrangement unit allocates a processor and time to execute to an instruction.

### Fifteenth Exemplary Embodiment

A program parallelization program according to a fifteenth exemplary embodiment is one for use with a computer that constitutes a program parallelization apparatus for inputting a sequential processing intermediate program and outputting a parallelized intermediate program intended for multithreaded parallel processors, the program parallelization program making the computer function as an instruction execution start and end time limitation select unit, a thread start time lamination analysis unit, a thread end time limitation analysis unit, an occupancy status analysis unit, a dependence delay analysis unit, a schedule candidate instruction select unit, an instruction arrangement unit, a parallel execution time measurement unit, and a best schedule determination unit.

The instruction execution start and end time limitation select unit selects a limitation from a set of limitations on the instruction execution start and end times of each thread.

The thread start time limitation analysis unit analyzes an instruction-allocatable time based on the limitation on the instruction execution start time of each thread.

The thread end time limitation analysis unit analyzes an instruction-allocatable time based on the limitation on the instruction execution end time of each thread.

The occupancy status analysis unit analyzes a time not occupied by already-scheduled instructions processor by processor.

The dependence delay analysis unit analyzes an instruction-allocatable time based on a delay resulting from dependence between instructions.

The schedule candidate instruction select unit selects a next instruction to schedule.

The instruction arrangement unit allocates a processor and time to execute to an instruction.

The parallel execution time measurement unit measures or estimates parallel execution time in response to a result of scheduling.

The best schedule determination unit changes the limitation and repeats scheduling to determine a best schedule.

### Sixteenth Exemplary Embodiment

A program parallelization program according to a sixteenth exemplary embodiment is one for use with a computer that constitutes a program parallelization apparatus for inputting a sequential processing program and outputting a parallelized program intended for multithreaded parallel processors, the program parallelization program making the computer function as a control flow analysis unit, a schedule area formation unit, an inter-instruction memory data flow analysis unit, an instruction execution start and end time limitation select unit, a thread start time lamination analysis unit, a thread end time limitation analysis unit, an occupancy status analysis unit, a dependence delay analysis unit, a schedule candidate instruction select unit, an instruction arrangement unit, a parallel execution time measurement unit, a best schedule determination unit, a register allocation unit, and a program output unit.

The control flow analysis unit analyzes the control flow of the input sequential processing program.

The schedule area formation unit refers to the result of analysis of the control flow by the control flow analysis unit and determines the area to be scheduled.

The register data flow analysis unit refers to the determination of the schedule area made by the schedule area formation unit and analyzes the data flow of a register.

The inter-instruction memory data flow analysis unit analyzes the dependence between an instruction to make a read or write to an address and an instruction to make a read or write from the address.

The instruction execution start and end time limitation select unit selects a limitation from a set of limitations on the instruction execution start and end times of each thread.

The thread start time limitation analysis unit analyzes an instruction-allocatable time based on the limitation on the instruction execution start time of each thread.

The thread end time limitation analysis unit analyzes an instruction-allocatable time based on the limitation on the instruction execution end time of each thread.

The occupancy status analysis unit analyzes a time not occupied by already-scheduled instructions processor by processor.

The dependence delay analysis unit analyzes an instruction-allocatable time based on a delay resulting from dependence between instructions.

The schedule candidate instruction select unit selects a next instruction to schedule.

The instruction arrangement unit allocates a processor and time to an instruction.

The parallel execution time measurement unit measures or estimates parallel execution time in response to a result of scheduling.

The best schedule determination unit changes the limitation and repeats scheduling to determine a best schedule.

The register allocation unit refers to the result of the best schedule determination unit and performs register allocation.

The program output unit refers to the result of the register allocation unit, and generates and outputs the parallelized program.

### Seventeenth Exemplary Embodiment

In a seventeenth exemplary embodiment, the schedule candidate instruction select unit analyzes a thread number and time to execute each of instructions that belong to a longest sequence of dependent instructions starting with a candidate instruction to schedule.

### Eighteenth Exemplary Embodiment

In an eighteenth exemplary embodiment, the instruction execution start and end time limitation select unit includes in the set of limitations only limitations on the execution start and end times such that a difference between the start time and end time is constant in all threads and the start time increases with the thread number by a constant increment.

According to the foregoing exemplary embodiments, it is possible to generate a parallelized program of shorter parallel execution time. The reasons will be described below.

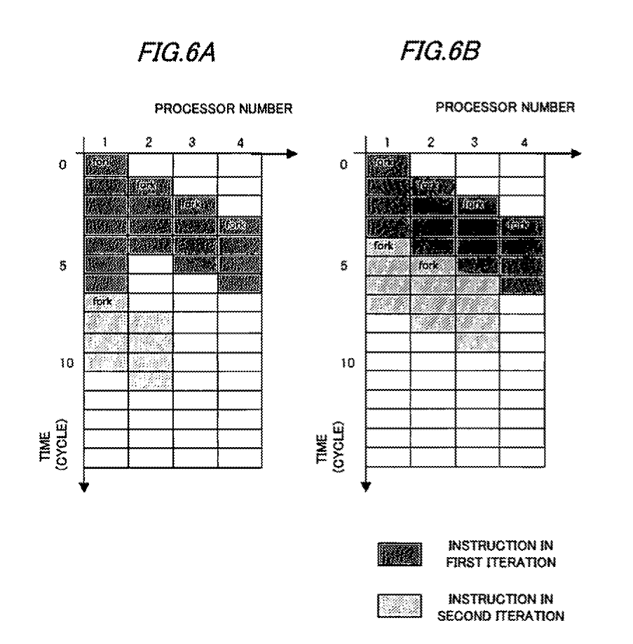

A first reason is that the reduction of idle time where no instruction is executed in each thread and equal numbers of instructions to execute in respective threads can reduce cycles where the processors execute no instruction. This will be described in conjunction with the example of FIG. 6 seen above.

In FIG. 6A, so many instructions are allocated to thread 1 that the processor 2 undergoes cycles where no instruction is executed. According to the exemplary embodiments, it is possible to allocate equal numbers of instructions as shown in FIG. 6B. This can reduce the cycles where no instruction is executed in the processor 2, with a reduction in parallel execution time.

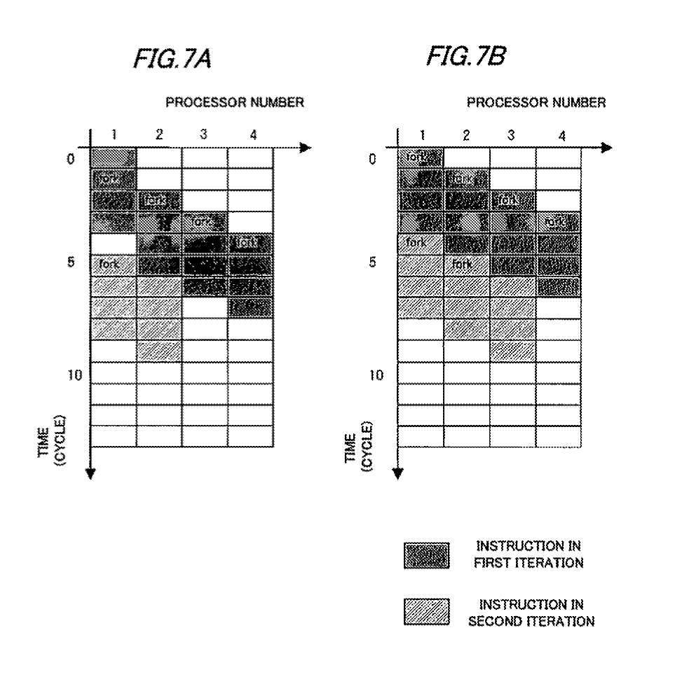

A second reason is that the reduction of idle time where no instruction is executed in each thread and uniform intervals between the execution start times of respective threads can reduce cycles where the processors execute no instruction. This will be described in conjunction with the example of FIG. 7 seen above.

In FIG. 7A, the processor 1 undergoes a cycle where no instruction is executed since the sequence of instructions allocated to thread 2 has a late start time. According to the exemplary embodiments, it is possible to allocate instructions with uniform intervals between the instruction execution start times as shown in FIG. 7B. This can reduce the cycle where no instruction is executed in the processor 1, with a reduction in parallel execution time.

In order to reduce the idle time where no execution is executed in each thread, make the numbers of instructions to execute in the respective threads uniform, and make the intervals between the execution start times of the respective threads uniform, it is needed to perform scheduling so as to reduce parallel execution time with a limitation imposed on the instruction start and end times of each thread. In order to reduce the parallel execution time of an instruction schedule, it is needed to predict the execution completion times of the last instructions in longest sequences of dependent instructions starting with respective unscheduled instructions, and schedule the first instruction of the latest time first. A longest sequence of dependent instructions refers to a sequence of instructions that has the latest execution end time among dependent sequences of instructions on a dependence graph. The reason is that if the scheduling of the first instruction in the sequence of instructions that completes its execution the latest is postponed, the execution completion time of the sequence of instructions can possibly be even greater. It is therefore needed to improve the prediction accuracy to predict the execution completion time of a sequence of instructions. For such a purpose, it is needed to accurately grasp thread numbers and times to which the first instruction can be scheduled, and accurately predict the execution time of the sequence of instructions.

According to the exemplary embodiments, the foregoing are made possible with a limitation imposed on the instruction start and end times of each thread. As a result, it is possible to reduce idle time where no instruction is executed in each thread, make the numbers of instructions to execute in respective threads uniform, and make the intervals between the execution start times of the respective threads uniform.

The reason why it is possible to accurately grasp thread numbers and times to which the first instruction in a sequence of instructions starting with the instruction on a dependence graph can be scheduled is that the instruction-allocatable thread numbers and times can be selected in consideration of the limitation on the instruction start and end times of each thread.

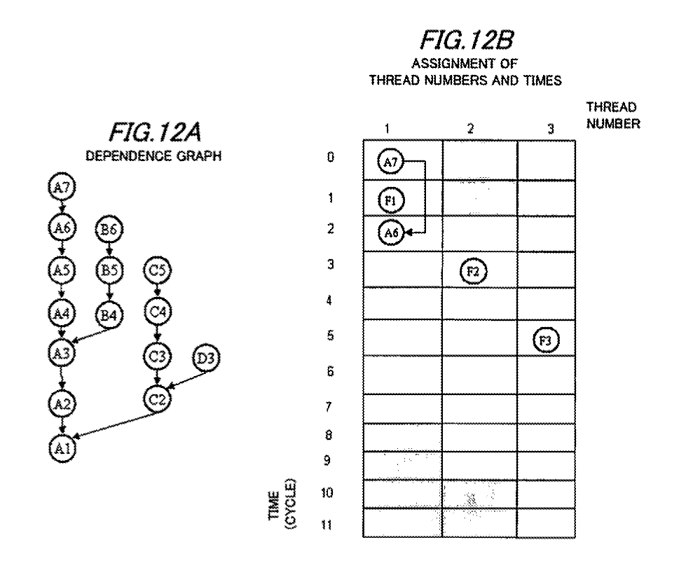

A concrete example will be given with reference to FIG. 12. Take the case of scheduling a sequence of instructions with an instruction dependence graph shown in FIG. 12A. The scheduling is performed under the limitation that the execution start interval is 2 and the number of instructions is eight. A fork instruction has a delay of one cycle. Suppose that instructions A7 and A6 are just scheduled. Instructions B6 and C5 are the next instruction candidates to schedule. The longest sequence of dependent instructions starting with the instruction B6 consists of B6 to B4 and A3 to A1. Check for an earliest schedule position for the instruction B6. It is shown that times 0 to 2 in thread number 1 are occupied by already-scheduled instructions. It is also shown that times 0 and 1 in thread number 2 are not available due to the start time limitation. Consequently, it is possible to accurately grasp that the earliest schedulable position is at thread number 2, time 2.

The execution time of the last instruction in a longest sequence of dependent instructions starting with a certain instruction can be accurately predicted for the following reasons.

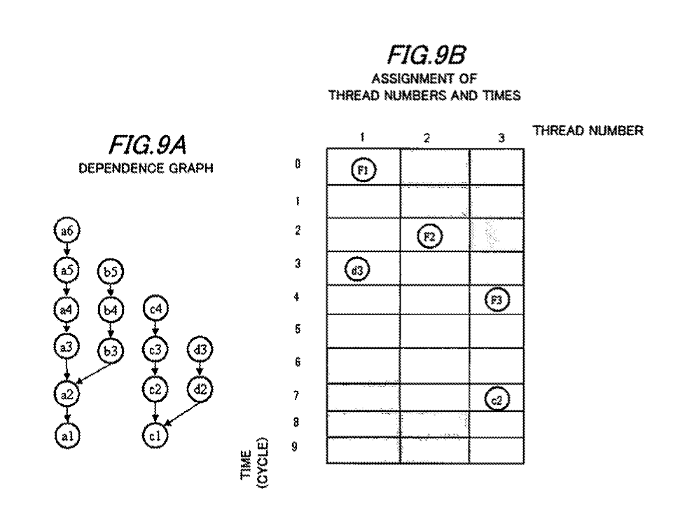

A first reason is that it is possible to predict the thread number and time to execute each instruction belonging to the longest sequence of dependent instructions. A concrete example will be given with reference to FIG. 9. Take the case of scheduling a sequence of instructions with a dependence graph shown in FIG. 9A. The scheduling is performed under the limitation that the execution start interval is 2 and the number of instructions is six. A fork instruction has a delay of two cycles. The transmission of a register value to an adjacent processor entails a delay of two cycles. Suppose, as shown in the diagram, that there is scheduled an instruction c2, and times 3 and 4 in thread number 1 are unoccupied. Now, let us consider scheduling an instruction d3. Assuming that the instruction d3 is allocated to thread number 1, time 3, predict the execution time of the last instruction c1 in the longest sequence of dependent instructions d3, d2, and c1 starting with the instruction d3. The instruction d2 is predicted to be allocated to thread number 1, time 4. The instruction c1 is dependent on the instruction c2, and the instruction c2 is allocated to thread number 3, time 7. In the intended parallel processor system, data can only be communicated from one instruction to another in directions where the thread number remains unchanged or increases. The thread number for the instruction c1 to be allocated to is thus three or higher. In view of this, the instruction c1 is predicted to be allocated to thread number 3, time 8. By such prediction of the thread numbers and times for the respective instructions d3, d2, and c1 to be allocated to, it is possible to predict the time of execution of the instruction c1 more accurately.

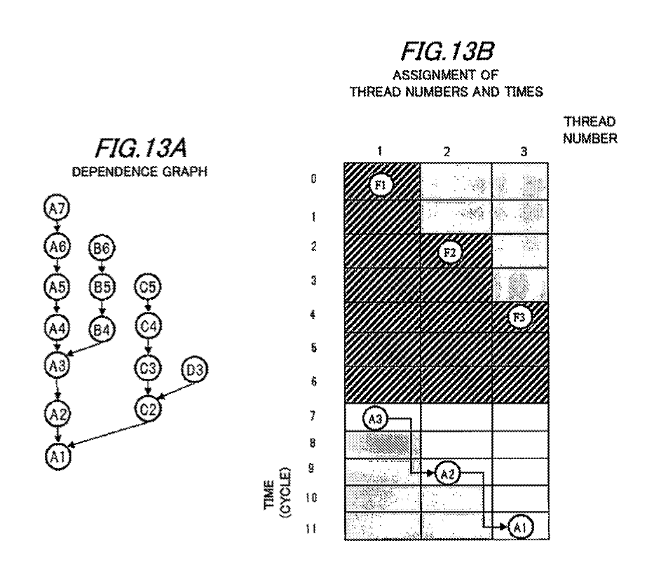

A second reason is that the execution time of a sequence of instructions can be predicted in consideration of the limitation on the instruction start and end times of each thread. A concrete example will be given with reference to FIG. 13. Take the case of scheduling a sequence of instructions with a dependence graph shown in FIG. 13A. The scheduling is performed under the limitation that the execution start interval is 2 and the number of instructions is eight. A fork instruction has a delay of two cycles. The communication of a register value between adjoining processors entails a delay of two cycles. Suppose that times 0 to 6 in thread number 1, times 2 to 6 in thread number 2, and times 4 to 6 in thread number 3 are occupied by already-scheduled instructions. Now, consider scheduling an instruction A3. Assuming here that the instruction A3 is allocated to thread number 1, time 7, predict the execution time of the last instruction A1 in the sequence of instructions starting with the instruction A3 on the dependence graph. It is shown that thread number 1, time 8 is not available due to the limitation on the execution start and end times. A2 is predicted to be executed in thread number 2, time 9 in consideration of the delay time for register value communication. It is also shown that thread number 2, time 10 is not available due to the limitation on the execution start and end times. A1 is predicted to be executed in thread number 3, time 11 in consideration of the delay time for register value communication. Consequently, it is possible to accurately predict the execution time of A1 for the situation where A1 is allocated to thread number 1, time 7.

Hereinafter, specific examples of the present invention will be described.

### Example 1

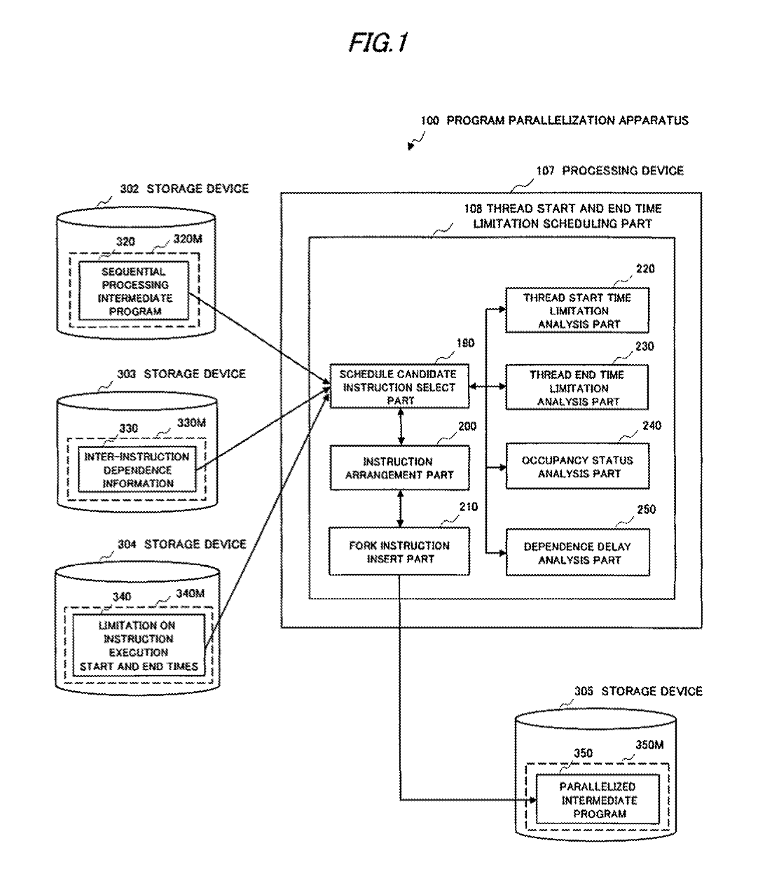

Referring to FIG. 1, a program parallelization apparatus 100 according to a first example of the present invention is an apparatus which inputs a sequential processing intermediate program 320 generated by a not-shown program analysis apparatus from a storing part 320M of a storage device 302, inputs inter-instruction dependence information 330 generated by a not-shown dependence analysis apparatus from a storing part 330M of a storage device 303, inputs a limitation 340 on instruction execution start and end times from a storing part 340M of a storage device 304, generates a parallelized intermediate program 350 in which the time and processor to execute each instruction are determined, and records the parallelized intermediate program 350 into a storing part 350M of a storage device 305.

The program parallelization apparatus 100 shown in FIG. 1 includes: the storage device 302 such as a magnetic disk which stores the sequential processing intermediate program 320 to be input; the storage device 303 such as a magnetic disk which stores the inter-instruction dependence information 330 to be input; the storage device 304 such as a magnetic disk which stores the limitation 340 on the instruction execution start and end times to be input; the storage device 305 such as a magnetic disk which stores the parallelized intermediate program 350 to be output; and a processing device 107 such as a central processing unit which is connected with the storage devices 302, 303, 304, and 305. The processing device 107 includes a thread start and end time limitation scheduling part 108.

Such a program parallelization apparatus 100 can be implemented by a computer such as a personal computer and a workstation, and a program. The program is recorded on a computer-readable recording medium such as a magnetic disk, is read by the computer on such an occasion as startup of the computer, and controls the operation of the computer, thereby implementing the functional units such as the thread start and end time limitation scheduling part 108 on the computer.

The thread start and end time limitation scheduling part 108 inputs the sequential processing intermediate program 320, the inter-instruction dependence information 330, and the limitation 340 on the instruction start and end times, and determines a schedule. Scheduling specifically refers to determining the execution thread number and execution time of each instruction. The thread start and end time limitation scheduling part 108 then determines the order of execution of instructions so as to carry out the determined schedule, and inserts fork instructions. The thread start and end time limitation scheduling part 108 then records the parallelized intermediate program 350, the result of parallelization.

The thread start and end time limitation scheduling part 108 includes: a thread start time limitation analysis part 220 which analyzes, for a thread, an instruction-allocatable thread number and time thread based on a limitation on the instruction execution start time; a thread end time limitation analysis part 230 which analyzes, for a thread, an instruction-allocatable thread number and time thread based on a limitation on the instruction execution end time; an occupancy status analysis part 240 which analyzes thread numbers and time slots that are occupied by already-scheduled instructions; a dependence delay analysis part 250 which analyzes an instruction-allocatable time based on a delay resulting from dependence between instructions; a schedule candidate instruction select part 190 which selects the next instruction to schedule based on the information on the thread start time limitation analysis part 220, the thread start time limitation analysis part 230, the occupancy status analysis part 240, and the dependence delay analysis part 250; an instruction arrangement part 200 which allocates instructions to slots, i.e., determines the execution times and execution threads of the instructions based on the determination of the schedule candidate instruction select part 190; and a fork insert part 210 which determines the order of execution of instructions so as to carry out the result of scheduling, and inserts fork instructions.

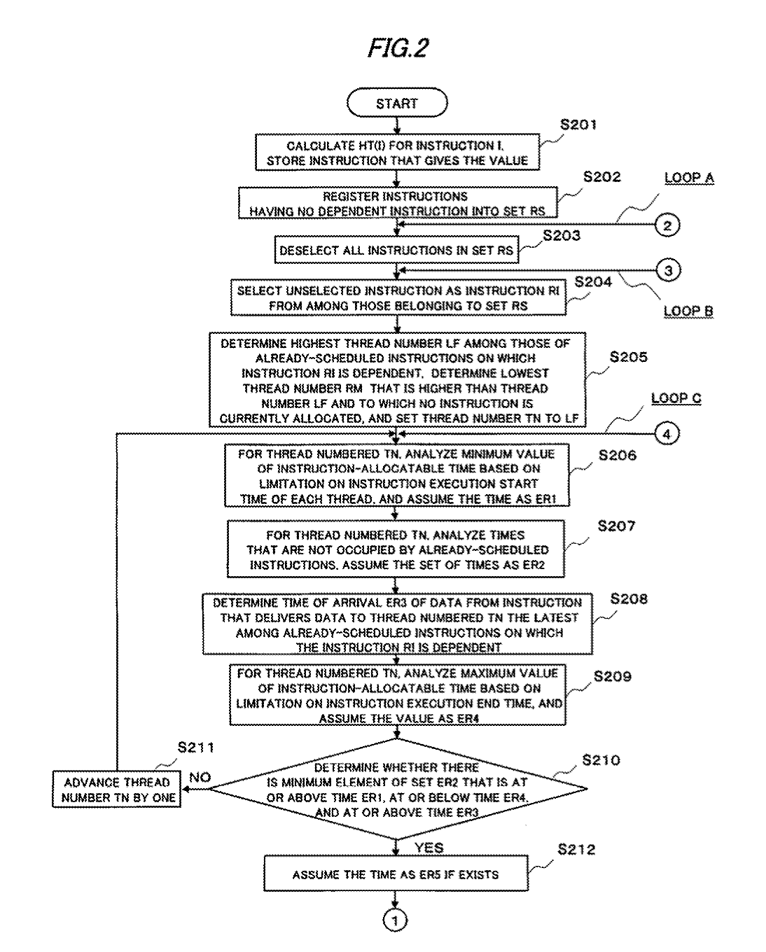

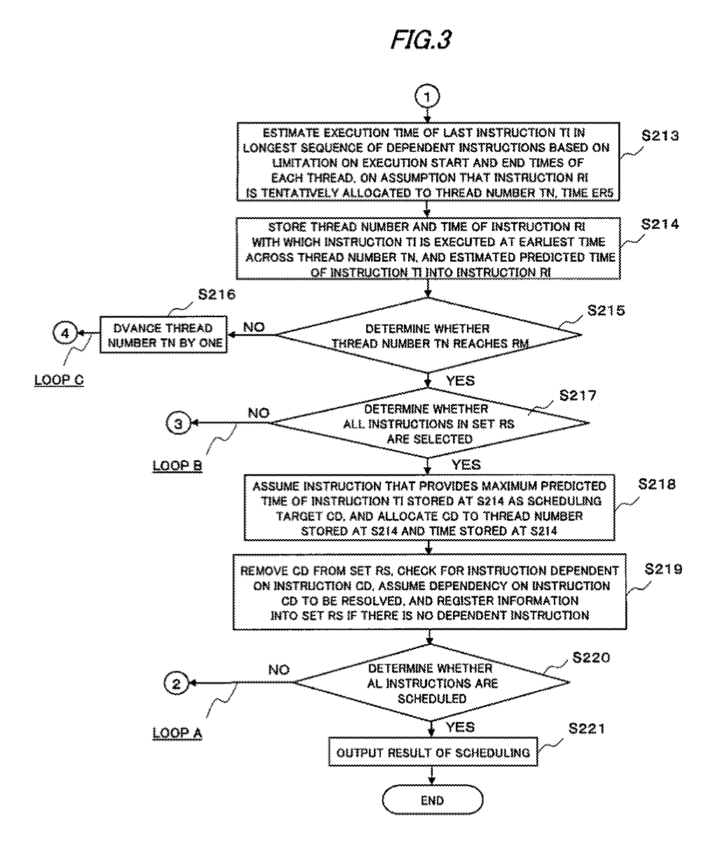

Next, the operation of the program parallelization apparatus 100 according to the present example will be described. In particular, the scheduling processing to be processed by the thread start and end time limitation scheduling part 108 with a limitation imposed on the instruction execution start and end times of each thread will be described with reference to FIGS. 2 and 3.

The thread start and end time limitation scheduling part 108 inputs the sequential processing intermediate program 320 from the storing part 320M of the storage device 302. The sequential processing intermediate program 320 is expressed in the form of a graph. Functions that constitute the sequential processing intermediate program 320 are expressed by nodes that represent the functions. Instructions that constitute the functions are expressed by nodes that represent the instructions. Loops may be converted into recursive functions and expressed as recursive functions. In the sequential processing intermediate program 320, there is defined a schedule area that is subjected to the instruction scheduling of determining the execution times and execution thread numbers of instructions. The schedule area, for example, may consist of a basic block or a plurality of basic blocks.

Next, the thread start and end time limitation scheduling part 108 inputs the inter-instruction dependence information 330 from the storing part 330M of the storage device 303. The dependence information 330 shows dependence between instructions which is obtained by the analysis of data flows and control flows associated with register and memory read and write. The dependence information 330 is expressed by directed links which connect nodes that represent instructions.

The thread start and end time limitation scheduling part 108 then inputs a limitation 340 on the instruction execution start and end times from the storing part 340M of the storage device 304. For example, the limitation 340 may be such that a difference between the start time and end time is constant in all threads and the start time increases with the thread number by a constant increment.

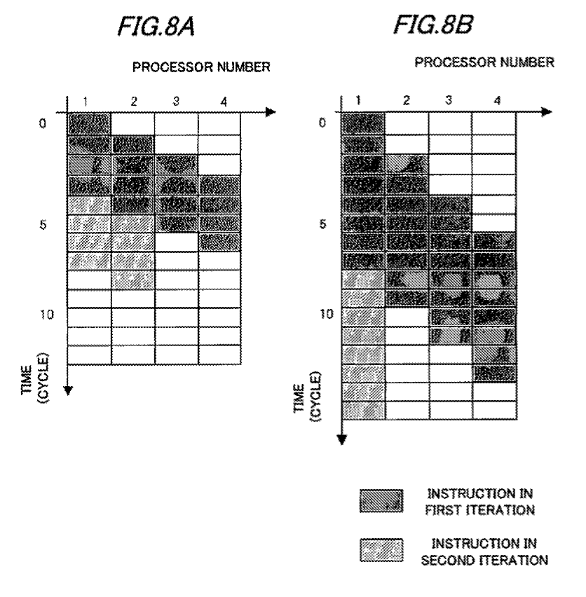

A concrete example will be given with reference to FIG. 8. In FIG. 8, each cell shows a thread number and a time slot. The colored cells indicate that instructions are assigned thereto. A limitation that the interval is one cycle and the number of instructions is four is that of instruction arrangement such as shown in FIG. 8A. A limitation that the interval is two cycles and the number of instructions is eight is that of instruction arrangement such as shown in FIG. 8B. A limitation may be employed such that the start time of each thread increases with the thread number by a constant increment but the number of instructions in each thread is not limited. A limitation may be employed such that only the number of instructions in each thread, is limited but not the start time of each thread.

Next, the thread start and end time limitation scheduling part 108 checks for a longest sequence of dependent instructions starting with each instruction. A longest sequence of dependent instructions refers to a sequence of instructions that has the latest execution end time among sequences of instructions on a dependence graph.

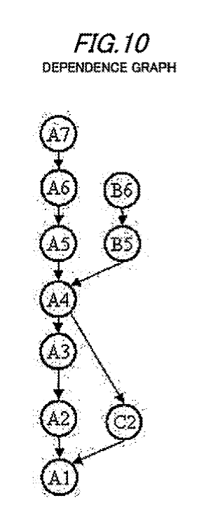

A concrete example will be given with reference to FIG. 10. In FIG. 10, the circles represent instructions. The arrows show dependence between the instructions. Here, an instruction A4 has two sequences of instructions starting with the instruction A4 on the dependence graph, namely, A4, A3, A2, and A 1, and A4, C2, and A1. Of these, the former includes a greater number of instructions and has longer execution time, and is thus estimated to have the latest execution end time.

To check for a longest dependent sequence of instructions starting with a certain instruction, the thread start and end time limitation scheduling part 108 calculates a value called HT(I) for each instruction I in the following way (step S201).

Assume a set of instructions that are dependent on the instruction I as DSET. Between respective elements DI of DSET, compare HT(DI) plus the communication time from I to DI to determine a maximum value MAXDSET. Finally, set HT(I) to MAXDSET plus the execution time of the instruction time I. The order of calculation is as follows.

Calculate HT(I) for each instruction IA such that the set of instructions dependent on the instruction IA is an empty set. Next, HT(I) is calculated for each instruction IB such that all the instructions dependent on the instruction IB are previously calculated. For each instruction IC, an instruction ID that is dependent on the instruction IC and gives MAXDSET is stored into the instruction IC. The sequence of instructions that is estimated to have the latest execution end time can be traced by tracing from IC to ID.

A concrete example will be given with reference to FIG. 10. In the instruction dependence graph shown in FIG. 10, the circles represent instructions. The arrows show dependence between the instructions. An instruction delay time is one cycle, and data communication time is zero cycles. The thread start and end time limitation scheduling part 108 starts calculating HT(I) with A1. HT(A1) is calculated to be 1. HT(A2) is then calculated to be 2. HT(A3) is calculated to be 3, and HT(C2) is calculated to be 2. For HT(A4), HT(A3) plus the communication time of zero from A3 to A4 is compared with HT(C2) plus the communication time of zero from A3 to A4. With the greater value selected, HT(A4) is calculated to be 4.

Next, the thread start and end time limitation scheduling part 108 registers instructions on which no instruction is dependent into a set RS (step S202).

Next, in order to process all the instructions in the set RS, the thread start and end time limitation scheduling part 108 marks unprocessed signals as unselected, thereby making a distinction from processed instructions. For that purpose, the thread start and end time limitation scheduling part 108 initially marks all the instructions as unselected (step S203).

Next, the thread start and end time limitation scheduling part 108 selects an unselected instruction belonging to the set RS as an instruction RI (step S204).

Next, the thread start and end time limitation scheduling part 108 determines a highest thread number LF among those of already-scheduled instructions on which the instruction RI is dependent. If there is no such instruction, LF is set to 1. The thread start and end time limitation scheduling part 108 determines a lowest thread number RM that is higher than the thread number LF and to which no instruction is currently allocated. The thread start and end time limitation scheduling part 108 sets a thread number TN to LF (step S205). The thread number TN indicates a thread number for the instruction RI to be allocated to. The thread number LF is the minimum value. The thread number RM is the maximum value. In the intended parallel processor system, data can only be communicated from one instruction to another in directions where the thread number remains unchanged or increases. Thus, a certain instruction can only be executed in a thread that has the same number as the highest thread number among those of dependent instructions, or in a thread that has a higher number. Consideration will thus be given only to thread numbers higher than or equal to LF.

Next, for the instruction RI and the thread numbered TN, the thread start and end time limitation scheduling part 108 analyzes instruction-allocatable times based on the limitation on the instruction execution start time of each thread, and assumes a set of the times as ER1 (step S206). Instruction-allocatable times are limited by the limitation on the instruction execution start time of each thread. For example, under the limitation on the instruction execution start time such that the start time of each thread increases with the thread number by a constant increment of two, times below 2×(N−1) are not available for the Nth thread.

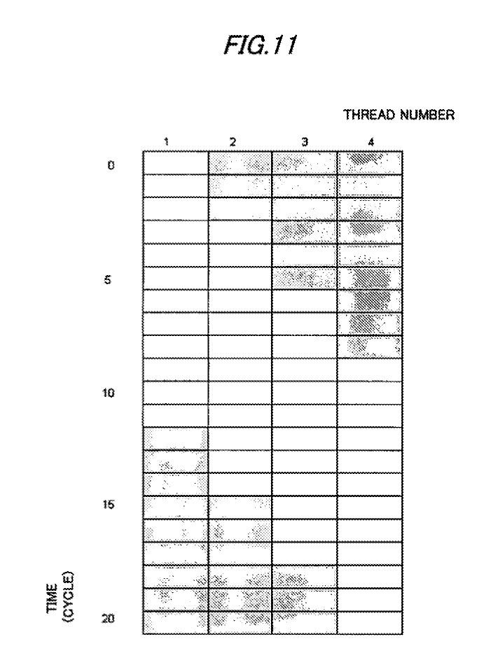

A concrete example will be given with reference to FIG. 11. In the example, a limitation on the instruction execution start time is employed such that the start time of each thread increases with the thread number by a constant increment of three. In the thread numbered 1, instructions can be allocated to from cycle 0. In the thread numbered 2, instructions are not allocatable to cycles 0 to 2. In the thread numbered 3, instructions are not allocatable to cycles 0 to 5. In the thread numbered 4, instructions are not allocatable to cycles 0 to 8.

Next, for the instruction RI and the thread numbered TN, the thread start and end time limitation scheduling part 108 analyzes times not occupied by already-scheduled instructions, and assumes a set of the times as ER2 (step S207). What time in what thread number is occupied by an already-scheduled instruction may be analyzed by using a method such as recording the allocated positions of already-scheduled instructions into a two-dimensional table of thread numbers and times and consulting the table.

Next, the thread start and end time limitation scheduling part 108 checks the already-scheduled instructions on which the instruction RI is dependent for the transmission of data to RI. If no data is transmitted, ER3=0. If any data is transmitted, the thread start and end time limitation scheduling part 108 checks the arrival times of the data from such instructions to the thread numbered TN. The thread start and end time limitation scheduling part 108 determines the maximum value of the arrival times as ER3 (step S208). If the register value of an instruction IB is dependent on that of an instruction IA, the instruction IA transmits register data to the instruction IB. The data to be transmitted may include register data and memory data, for example.

Next, for the instruction RI and the thread numbered TN, the thread start and end time limitation scheduling part 108 analyzes the maximum value of the instruction-allocatable times based on the limitation on the instruction execution end time, and assumes the value as ER4 (step S209).

Next, the thread start and end time limitation scheduling part 108 determines whether there is a minimum element of the set ER2 that is at or above the time ER1, at or below the time ER4, and at or above the time ER3 (step S210).

If there is no minimum element, the thread start and end time limitation scheduling part 108 advances the thread number TN by one and returns the control to step S206 (step S211).

If there is a minimum element, the thread start and end time limitation scheduling part 108 assumes the time as ER5 (step S212).

Next, the thread start and end time limitation scheduling part 108 estimates the execution time of the last instruction TI in the longest sequence of dependent instructions starting with the instruction RI based on the limitation on the execution start and end times of each thread, on the assumption that the instruction RI is tentatively allocated to the thread number TN and the time ER5 (step S213). This step will be described in more detail later.

Next, the thread start and end time limitation scheduling part 108 changes the thread number and predicts the execution time of the instruction RI since the predicted value of the execution time of the last instruction TI in the longest sequence of dependent instructions starting with the instruction RI may vary with the change of the thread number to which the instruction RI is assigned. The thread start and end time limitation scheduling part 108 stores the thread number and time of allocation of the instruction RI that minimize the predicted value, and the predicted time of the instruction TI into the instruction RI (step S214).

The thread number TN to allocate the instruction RI is changed from LF up to RM. The thread start and end time limitation scheduling part 108 therefore makes a determination whether the thread number TN reaches RM (step S215).

If the thread number TN does not reach the thread number RM, the thread start and end time limitation scheduling part 108 advances TN by one and returns the control to step S206 (step S216).

If the thread number TN reaches the thread number RM, the thread start and end time limitation scheduling part 108 then determines whether all the instructions in the set RS are selected. If all the instructions are not selected, the thread start and end time limitation scheduling part 108 returns the control to step S204 (step S217).

If all the instructions are selected, the thread start and end time limitation scheduling part 108 assumes the instruction that provides the maximum predicted time of the instruction TI stored in S214 as a scheduling target CD, and schedules the scheduling target CD to the stored thread number and the stored time (step S218). In order to reduce the parallel execution time of an instruction schedule, it is needed to select an unscheduled instruction such that the longest sequence of dependent instructions starting with the instruction is predicted to have the latest execution completion time, and schedule the first instruction first. The reason is that if the scheduling of the first instruction in the latest sequence of instructions is postponed, the execution completion time of the sequence of instructions can possibly be even greater. The thread start and end time limitation scheduling part 108 therefore gives priority to scheduling the instruction that provides the maximum predicted time of the instruction TI. If there are a plurality of maximum instructions, priority may be given to one with HT(I) of higher value, for example.

Next, the thread start and end time limitation scheduling part 108 removes the instruction CD from the set RS. The thread start and end time limitation scheduling part 108 checks for instructions that are dependent on the instruction CD, and assumes that the dependence of such instructions on the instruction CD is resolved. If the instructions have no other instruction to depend on, the thread start and end time limitation scheduling part 108 registers such instructions into the set RS (step S219).

Next, the thread start and end time limitation scheduling part 108 determines whether all the instructions are scheduled. If all the instructions are not scheduled, the thread start and end time limitation scheduling part 108 returns the control to step S203 (step S220).

Finally, if all the instructions are scheduled, the thread start and end time limitation scheduling part 108 outputs the result of scheduling (step S221), and ends the processing.

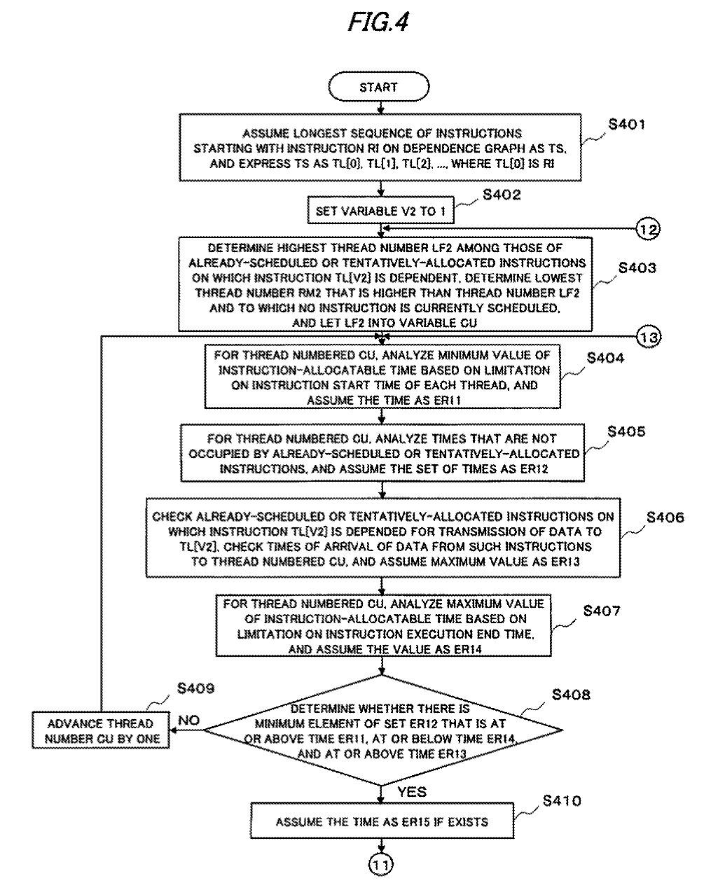

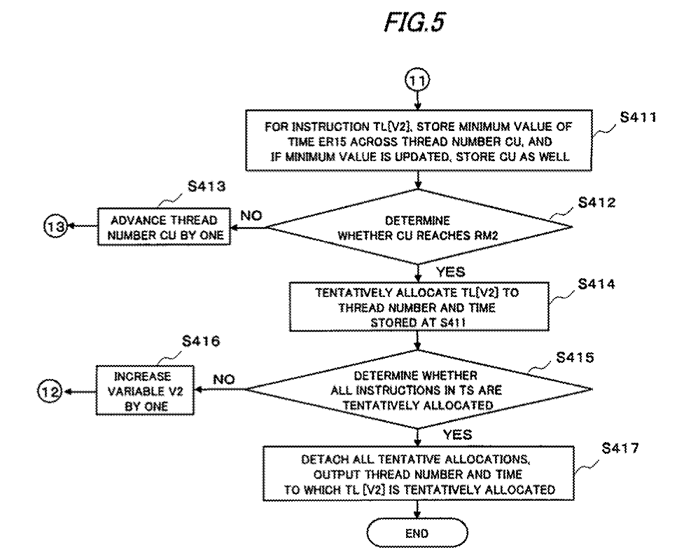

Next, the processing corresponding to step S213 in the scheduling processing to be processed by the thread start and end time limitation scheduling part 108 with a limitation imposed on the instruction execution start and end times of each thread will be described in detail with reference to FIGS. 4 and 5.

Initially, the thread start and end time limitation scheduling part 108 determines a longest sequence of instructions TS starting with the instruction RI on the dependence graph, and expresses TS as TL[0], TL[1], TL[2], . . . , where TL[0] is RI (step S401). For example, the longest sequence of instructions may be determined in the following way. That is, in calculating HT(RI), the longest sequence of instructions is determined by repeating the operation of tracing from an instruction RI, which stores an instruction RJ that is dependent on RI and that determines the value of HT(RI), to the instruction RJ and further to an instruction RK that is stored in the instruction RJ.

Next, the thread start and end time limitation scheduling part 108 sets a variable V2 to 1 (step S402). The variable V2 is a variable for tracing the sequence of instructions TS.

Next, the thread start and end time limitation scheduling part 108 determines a highest thread number LF2 among those of already-scheduled or tentatively-allocated instructions on which TL[V2] is dependent. If there is no such instruction, LF2 is set to 1. The thread start and end time limitation scheduling part 108 determines a lowest thread number RM2 that is higher than the thread number LF2 and to which no instruction is currently allocated. The thread start and end time limitation scheduling part 108 substitutes LF2 into a variable CU (step S403). The variable CU indicates the thread number for TL[V2] to be tentatively allocated to. For scheduled or tentatively-allocated instructions, dependence-based delay is taken into account since the thread numbers and times are known.

Next, for a thread numbered CU, the thread start and end time limitation scheduling part 108 analyzes the minimum value of the instruction-allocatable time based on the limitation on the instruction execution start time of each thread, and assumes the time as ER11 (step S404).

Next, for the thread numbered CU, the thread start and end time limitation scheduling part 108 analyzes times not occupied by already-scheduled instructions, and assumes a set of the times as ER12 (step S405).

Next, the thread start and end time limitation scheduling part 108 checks the already-scheduled or tentatively-allocated instructions on which TL[V2] is dependent for the transmission of data to the instruction TL[V2]. If no data is transmitted, ER13=0. If any data is transmitted, the thread start and end time limitation scheduling part 108 checks the times of arrival of the data from such instructions to the thread numbered CU. The thread start and end time limitation scheduling part 108 determines the maximum value of the arrival times as ER13 (step S406).

Next, for the thread numbered CU, the thread start and end time limitation scheduling part 108 analyzes the maximum value of the instruction-allocatable times based on the limitation on the instruction execution end time, and assumes the value as ER14 (step S407).

Next, the thread start and end time limitation scheduling part 108 determines whether there is a minimum element of the set ER12 that is at or above the time ER11, at or below the time ER14, and at or above the time ER13 (step S408). If there is no minimum element, the thread start and end time limitation scheduling part 108 advances the thread number CU by one and returns the control to S404 (step S409). If there is a minimum element, the thread start and end time limitation scheduling part 108 assumes the time as ER15 (step S410).

Next, for the instruction TL[V2], the thread start and end time limitation scheduling part 108 changes the thread number and checks the minimum value of the time ER15. The thread start and end time limitation scheduling part 108 stores the minimum value of the time ER15 of the instruction TL[V2] across the thread number CU, and if the minimum value is updated, stores CU as well (step S411).

Next, the thread start and end time limitation scheduling part 108 changes the thread number CU to assign the instruction TL[V2] to from LF2 up to RM2. The thread start and end time limitation scheduling part 108 thus determines whether the thread number CU reaches RM2 (step S412). If RM2 is not reached, the thread start and end time limitation scheduling part 108 increases the thread number CU by one (step S413) and returns the control to step S404. If RM2 is reached, the thread start and end time limitation scheduling part 108 tentatively allocates TL[V2] to the thread number and time stored at step S411 (step S414). A tentative allocation and an instruction schedule-based allocation are distinguished for later cancellation.

Next, the thread start and end time limitation scheduling part 108 determines whether all the instructions in TS are tentatively allocated (step S415). If all the instructions are not tentatively allocated, the thread start and end time limitation scheduling part 108 increases the variable V2 by one and returns the control to step S403 (step S416). If all the instructions are tentatively allocated, the thread start and end time limitation scheduling part 108 erases all the information on the tentative allocations, returns the thread number and time of the slot of TL[V2], and ends the processing (step S416). Here, TL[V2] is the last instruction in the longest sequence of dependent instructions starting with the instruction RI.

Next, the effects of the present example will be described.

According to the present example, it is possible to generate a parallelized program of shorter parallel execution time. The reasons will be described below.

A first reason is that the reduction of idle time where no instruction is executed in each thread and equal numbers of instructions to execute in respective threads can reduce cycles where the processors execute no instruction. This will be described in conjunction with the example of FIG. 6. In FIG. 6, each cell shows a thread number and a time slot. The colored cells indicate that instructions are assigned thereto. The coloring is intended to make a distinction between a plurality of threads running on the same processor. In FIG. 6A, so many instructions are allocated to thread 1 that the processor 2 undergoes cycles where no instruction is executed. According to the present example, it is possible to allocate equal numbers of instructions as shown in FIG. 6B. This can reduce the cycles where no instruction is executed in the processor 2, with a reduction in parallel execution time.

A second reason is that the reduction of idle time where no instruction is executed in each thread and uniform intervals between the execution start times of respective threads can reduce cycles where the processors execute no instruction. This will be described in conjunction with the example of FIG. 7. In FIG. 7A, the processor 1 undergoes a cycle where no instruction is executed since the sequence of instructions allocated to thread 2 has a late start time. According to the present example, it is possible to allocate instructions with uniform intervals between the instruction execution start times as shown in FIG. 7B. This can reduce the cycle where no instruction is executed in the processor 1, with a reduction in parallel execution time.

In order to reduce idle time where no execution is executed in each thread, make the numbers of instructions to execute in respective threads uniform, and make the intervals between the execution start times of the respective threads uniform, it is needed to perform scheduling so as to reduce parallel execution time with a limitation imposed on the instruction execution start and end times of each thread. In order to reduce the parallel execution time of an instruction schedule, it is needed to predict the execution completion times of the last instructions in longest sequences of dependent instructions starting with respective unscheduled instructions, and schedule the first instruction of the latest time first. A longest sequence of dependent instructions refers to a sequence of instructions that has the latest execution end time among dependent sequences of instructions on a dependence graph. The reason is that if the scheduling of the first instruction in the sequence of instructions that completes its execution the latest is postponed, the execution completion time of the sequence of instructions can possibly be even greater. It is therefore needed to improve the prediction accuracy to predict the execution completion time of a sequence of instructions. For such a purpose, it is needed to accurately grasp thread numbers and times to which the first instruction can be scheduled, and accurately predict the execution time of the sequence of instructions. According to the present example, the foregoing are made possible with a limitation imposed on the instruction execution start and end times of each thread. As a result, it is possible to reduce idle time where no instruction is executed in each thread, make the numbers of instructions to execute in respective threads uniform, and make the intervals between the execution start times of the respective threads uniform.

The reason why it is possible to accurately grasp thread numbers and times to which the first instruction in a sequence of instructions on a dependence graph starting with the instruction can be scheduled is that the instruction-allocatable thread numbers and times can be selected in consideration of the limitation on the instruction execution start and end times of each thread.

The execution time of the last instruction in a longest sequence of dependent instructions starting with a certain instruction can be accurately predicted for the reasons that: it is possible to predict the thread number and time to execute each instruction belonging to the longest sequence of dependent instructions; and it is possible to predict the execution time of the sequence of instructions in consideration of the limitation on the instruction start and end times of each thread.

### Concrete Example

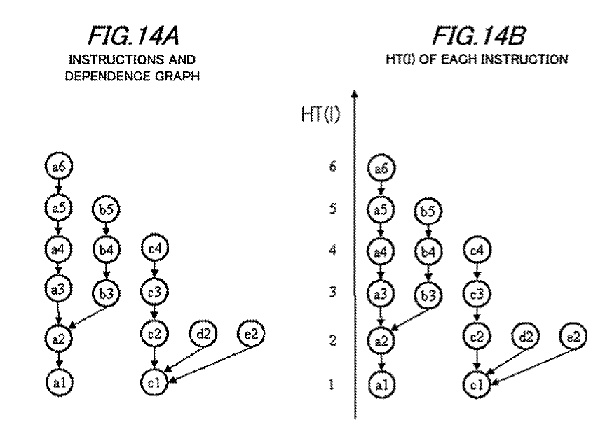

Referring to FIG. 14, a concrete example of the processing of the thread start and end time limitation scheduling part 108 in the program parallelization apparatus 100 according to the first example will be described.

FIG. 14A is a diagram showing a sequential processing intermediate program to be input and inter-instruction dependence information to be input. The circles represent instructions. The arrows show dependence between the instructions. The limitation on the execution start and end times of the instructions to be input is such that a difference between the start time and end time has a constant value of six in all threads and the start time increases with the thread number by a constant increment of two. The number of processors is three. All the instructions have a delay time of one cycle. Fork instructions have a delay time of two cycles. A delay time for communicating register data between instructions is 2+(j−i−1)*1 cycles, where the data is transmitted from a thread of thread number i to a thread of thread number j. To implement the limitation on the instruction execution start and end times of each thread, a fork instruction is previously allocated to a time p*2 in a thread of thread number p.

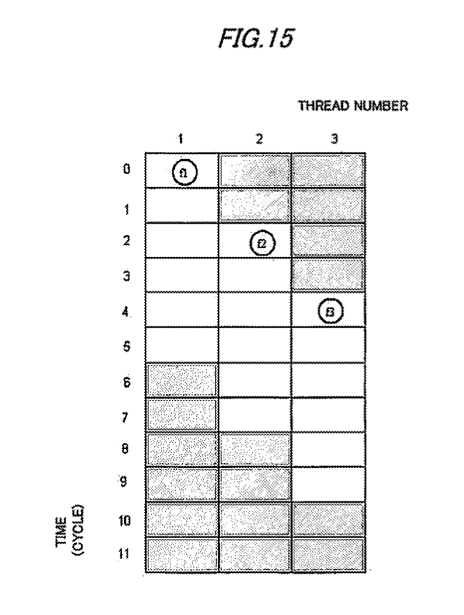

FIG. 15 shows the limitation on the instruction execution start and end times of each thread, and fork instructions. Instructions are allocated to non-gray cells. Instructions f1 to f3 are previously-allocated fork instructions.

Next, the operation of the thread start and end time limitation schedule part 108 according to the first example will be detailed in conjunction with the concrete example shown in FIG. 14A, with reference also to the flowcharts of FIGS. 2 to 5.

Initially, at step S201, the thread start and end time limitation scheduling part 108 calculates HT(I) for each instruction I. The calculations are as shown in FIG. 14B since all the instructions have a delay time of one cycle. For example, HT(instruction a6) is six. The instruction that gives an instruction HT(I) is one that is dependent on the instruction. For example, such an instruction for the instruction a7 is the instruction a6.

Next, at step S202, the thread start and end time limitation scheduling part 108 registers the instructions a6, b5, c4, d2, and e2, which are not dependent on any instruction, into a set RS.

Next, at step S203, the thread start and end time limitation scheduling part 108 deselects all the instructions in the set RS.

Next, at step S204, the thread start and end time limitation scheduling part 108 selects an unselected instruction a6, among the instructions belonging to the set RS, as an instruction RI.

Next, at step S205, the thread start and end time limitation scheduling part 108 sets the thread number LF to 1 since there is no instruction on which the instruction a6 is dependent. The thread start and end time limitation scheduling part 108 thus sets the thread number RM to 2 since the lowest thread number that is higher than LF and to which no instruction is allocated is 2. The thread start and end time limitation scheduling part 108 sets the thread number TN to LF, i.e., 1.

Next, at step S206, the thread start and end time limitation scheduling part 108 sets the time ER1 to 0 since instructions can be allocated to from cycle 0 in the thread numbered 1 according to the limitation on the instruction execution start time of each thread.

Next, at step S207, the thread start and end time limitation scheduling part 108 assumes, for the thread numbered 1, that the set ER2 includes all cycles except 0 since the instruction f1 is allocated to cycle 0.

Next, at step S208, the thread start and end time limitation scheduling part 108 sets ER3 to 0 since there is no instruction on which the instruction a6 is dependent.

Next, at step S209, the thread start and end time limitation scheduling part 108 sets the time ER4 to 5 since instructions can be allocated up to cycle 5 in the thread numbered 1 according to the limitation on the instruction execution end time.

Next, at step S210, a minimum element of the set ER2 that is at or above the time ER1, at or below the time ER4, and at or above the time ER3 is 1, i.e., exists. The thread start and end time limitation scheduling part 108 therefore moves the control to step S212.

Next, at step S212, the thread start and end time limitation scheduling part 108 sets the time ER5 to 1.

Next, at step S213, the thread start and end time limitation scheduling part 108 estimates the execution time of the last instruction TI in the longest sequence of dependent instructions to which the instruction RI belongs based on the limitation on the execution start and end times of each thread, on the assumption that the instruction RI is tentatively allocated to the thread number TN and the time ER5.

Turn to FIG. 3. Initially, at step S401, the thread start and end time limitation scheduling part 108 assumes a sequence of instructions a6, a5, a4, a3, a2, and a1 to be TS since the sequence of instructions is the longest among those starting with the instruction a6 on the dependence graph.

Next, at step S402, the thread start and end time limitation scheduling part 108 sets the variable V2 to 1.

Next, at step S403, the thread start and end time limitation scheduling part 108 sets the thread number LF2 to 1 since TL[1] is the instruction a5 and the instruction a5 is dependent on the instruction a6. The thread start and end time limitation scheduling part 108 sets the thread number RM2 to 2 since the lowest number among those of threads to which no instruction is currently allocated is 2. The thread start and end time limitation scheduling part 108 substitutes LF2, i.e., 1 into the variable CU.

Next, at step S404, the thread start and end time limitation scheduling part 108 sets the time ER11 to 0 since instructions can be allocated to times 0 and above in the thread numbered 1 based on the limitation on the instruction execution start time of each thread.

Next, at step S405, the thread start and end time limitation scheduling part 108 assumes that the set ER12 includes times other than 0 and 1 since an instruction is allocated to time 0 and an instruction is tentatively allocated to time 1 in the thread numbered 1.

Next, at step S406, the thread start and end time limitation scheduling part 108 sets ER13 to time 2 since the instruction a5 is dependent on the instruction a6.

Next, at step S407, the thread start and end time limitation scheduling part 108 sets the time ER14 to 5 since instructions are only allocatable to times 5 and below in the thread numbered 1 based on the limitation on the instruction execution end time.

Next, at step S408, a minimum element of the set ER12 that is at or above the time ER11, at or below the time ER14, and at or above the time ER13 is 2, i.e., exists. The thread start and end time limitation scheduling part 108 therefore moves the control to step S410.

Next, at step S410, the thread start and end time limitation scheduling part 108 sets the time ER15 to 2.

Next, at step S411, the thread start and end time limitation scheduling part 108 stores the minimum value of time, 2. The thread start and end time limitation scheduling part 108 also stores the value of the thread number CU, 1.

Next, at step S412, the thread number RM2 is 1. Since CU does not reach 2, the thread start and end time limitation scheduling part 108 advances the thread number CU by one at step S413, and returns the control to S404.

The second iteration of the loop consisting of steps S404 to S413 is performed the same as the first iteration. The second iteration will thus be described only in outline. At step S404, the time ER11 is set to 2. At step S405, ER12 is set to 3 since a fork instruction is allocated to time 2. At step S406, the instruction a5 is dependent on the instruction a6 and the instruction a6 is tentatively allocated to thread number 1, time 1. If data is transmitted to thread number 2, the time of arrival will be time 3. ER13 is thus time 3. At step S407, the time ER14 is set to 7. At step S410, the time ER15 is 3. At step S411, the minimum value of time is not updated. At step S412, the variable CU reaches the thread number RM2, and the control proceeds to S414.

Next, at step S414, the thread start and end time limitation scheduling part 108 tentatively allocates the instruction a5 to thread number 1, time 2.

Next, at step S415, the thread start and end time limitation scheduling part 108 moves the control to step S416 since TS includes instructions that are not tentatively allocated yet.

Next, at step S416, the thread start and end time limitation scheduling part 108 increases the variable V2 by one and moves the control to step S403.

The second iteration of the loop consisting of steps S403 to S416 is performed the same as the first iteration. TL[2] is the instruction a4, which is tentatively allocated to thread number 1, time 3. TL[3] is the instruction a3, which is tentatively allocated to thread number 1, time 4. TL[4] is the instruction a2, which is tentatively allocated to thread number 1, time 5.

The fifth iteration will now be described. TL[5] is the instruction a1. At step S403, the variable CU is set to 1. At step S405, the set ER12 includes times other than 0 to 5. In thread number 1, instructions are only allocatable to times 5 and below due to the limitation on the instruction execution end interval. Thus, at step S407, the time ER14 is 5. At step S408, it is shown that there is no time in thread number 1 to which the instruction a2 is allocatable. At step S409, the variable CU which indicates the thread number for the instruction a2 to be allocated to is therefore changed to two, and the control proceeds to step S404. The instruction a1 is dependent on the instruction a2 at thread number 1, time 5. The transmission of data from the instruction a2 to thread number 2 entails a delay time of two cycles. At step S406, the time ER13 is thus 7. Consequently, the instruction a1 is tentatively allocated to thread number 2, time 7.

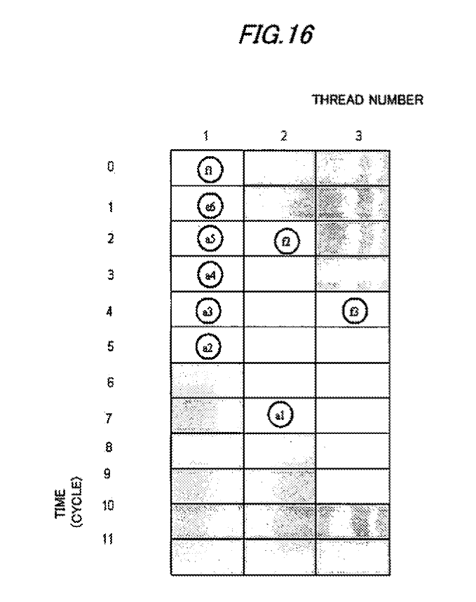

FIG. 16 shows the result of tentative allocation of the sequence of instructions a6 to a1 on the assumption that the instruction a6 is allocated to thread number 1, time 1.

At step S415, the thread start and end time limitation scheduling part 108 moves the control to step S417 since all the instructions in the sequence of instructions TS are tentatively allocated.

At step S417, the thread start and end time limitation scheduling part 108 detaches all the tentative allocations, outputs thread number 2 and time 7 to which the instruction TL[V2], i.e., the instruction a1 is tentatively allocated, and ends the processing.

Return to FIGS. 2 and 3. At step S214, the thread start and end time limitation scheduling part 108 stores thread number 1 and time 1 of the instruction a6, and time 7 of the instruction a1.

At step S215, the thread number RM is 2. Since the thread number TN is 1, the thread start and end time limitation scheduling part 108 determines that the thread number TN does not reach RM yet, and moves the control to step S216.

At step S216, the thread start and end time limitation scheduling part 108 advances the thread number TN by one and moves the control to step S206.

In the following description, the loop consisting of steps S206 to S216 will be referred to as a “loop C.” The second iteration of the loop C is performed the same as the first iteration. The second iteration will thus be described only in outline. Initially, at step S206, the time ER1 is set to 2 due to the limitation on the instruction execution start time of each thread. At step S207, the set ER2 is assumed to include other than 2 since a fork instruction is allocated to time 2. At step S208, ER3 is set to 0 since there is no instruction that is dependent on the instruction a6. At step S209, the time ER4 is set to 7. Through steps S210 and S212, ER5 is set to 3. At step S213, the thread start and end time limitation scheduling part 108 tentatively allocates the longest sequence of dependent instructions a6 to a1 starting with the instruction a6 and estimates the execution time of the instruction a1 that is the latest to be executed in the sequence of instructions, on the assumption that the instruction a6 is tentatively allocated to thread number 2, time 3.

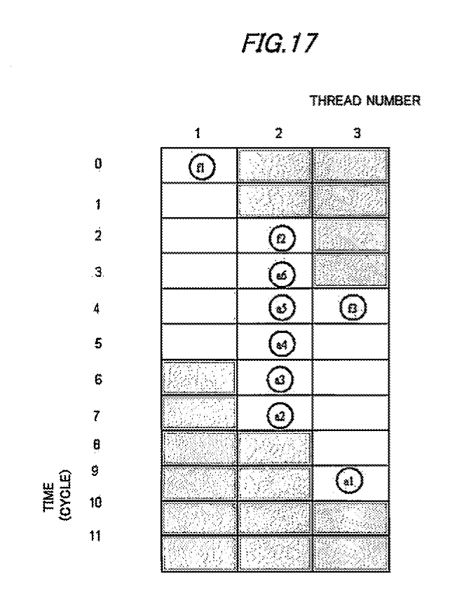

FIG. 17 shows the result of tentative allocation of the sequence of instructions a6 to a1 on the assumption that the instruction a6 is allocated to thread number 2, time 3.

At step S214, time 9 of the instruction a1 is not stored since it is greater than the previously stored value.

At step S215, the thread number TN is 2. The thread start and end time limitation scheduling part 108 determines that the thread number TN reaches RM, and moves the control to step S217.

At step S217, the thread start and end time limitation scheduling part 108 returns the control to step S204 since there are instructions that are not allocated yet.

In the following description, the loop consisting of steps S204 to S217 will be referred to as a “loop B.” The second iteration of the loop B is performed the same as the first iteration. The second iteration will thus be described only in outline. At step S204, the instruction b5 is selected as the instruction RI. In S205 to S212, the thread number TN is set to 1, and the time ER5 is set to time 1. At step S213, assuming that the instruction b5 is allocated to the thread number and time, the thread start and end time limitation scheduling part 108 tentatively allocates a longest sequence of dependent instructions b5 to b3, a2, and a1 starting with the instruction b5. The thread start and end time limitation scheduling part 108 then estimates the execution time of the last instruction a1 in the sequence of instructions.

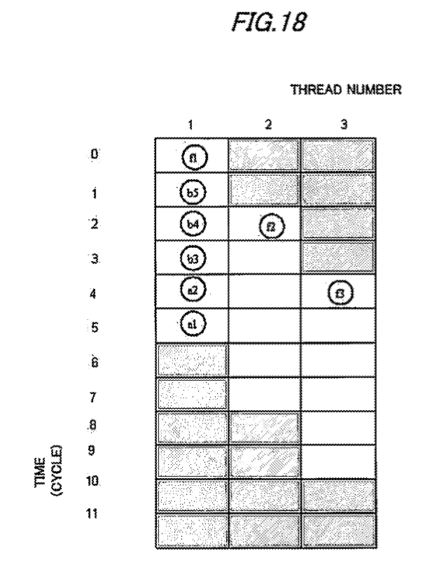

FIG. 18 shows the result of tentative allocation of the sequence of instructions b5 to b3, a2, and a1 on the assumption that the instruction a5 is allocated to thread number 1, time 1.

For the instruction b5, the result shows the case where the instruction a1 is executed at the earliest time. Description of steps S215 and S216 and the second iteration of the loop C will thus be omitted. The loop C is repeated only twice before the control proceeds to step S217.

At step S217, the thread start and end time limitation scheduling part 108 returns the control to step S204 since there are instructions that are not allocated yet.

The third iteration of the loop B will be outlined. For the instruction c4, the longest sequence of dependent instructions starting with the instruction c4 consists of the instructions c4 to c1. The allocation of the instruction c4 that provides the earliest execution time of the instruction c1 is thread number 1, time 1, in which case the instruction c1 is allocated to thread number 1, time 4.

The fourth iteration of the loop B will be outlined. For the instruction d2, the longest sequence of dependent instructions starting with the instruction d2 consists of the instructions d2 and c1. The allocation of the instruction d2 that provides the earliest execution time of the instruction c1 is thread number 1, time 1, in which case the instruction c1 is allocated to thread number 1, time 2.

The fifth iteration of the loop B will be outlined. For the instruction e2, the longest sequence of dependent instructions starting with the instruction d2 consists of the instructions e2 and c1. The allocation of the instruction e2 that provides the earliest execution time of the instruction c1 is thread number 1, time 1, in which case the instruction c1 is allocated to thread number 1, time 2.

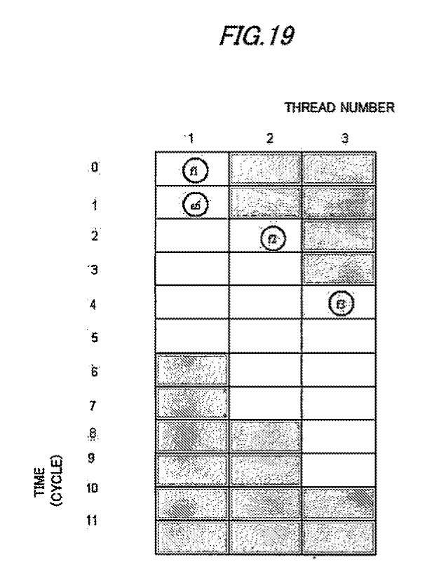

Next, at step S218, the thread start and end time limitation scheduling part 108 selects an instruction that maximizes the execution time of the last instruction in the longest sequence of dependent instructions starting with the instruction from among those belonging to the set RS. Here, time 7 of the instruction a1 in the longest sequence of dependent instructions a6 to a1 with the instruction a6 is the maximum. The thread start and end time limitation scheduling part 108 therefore selects the instruction a6, and allocates the instruction a6 to thread number 1, time 1. FIG. 19 shows the result of scheduling.

At step S219, the thread start and end time limitation scheduling part 108 removes the instruction a6 from the set RS. The thread start and end time limitation scheduling part 108 registers the instruction a5 that has been dependent on the instruction a6 into the set RS since the dependence has been only on the instruction a6.

At step S220, the thread start and end time limitation scheduling part 108 returns the control to step S203 since there are still unscheduled instructions.

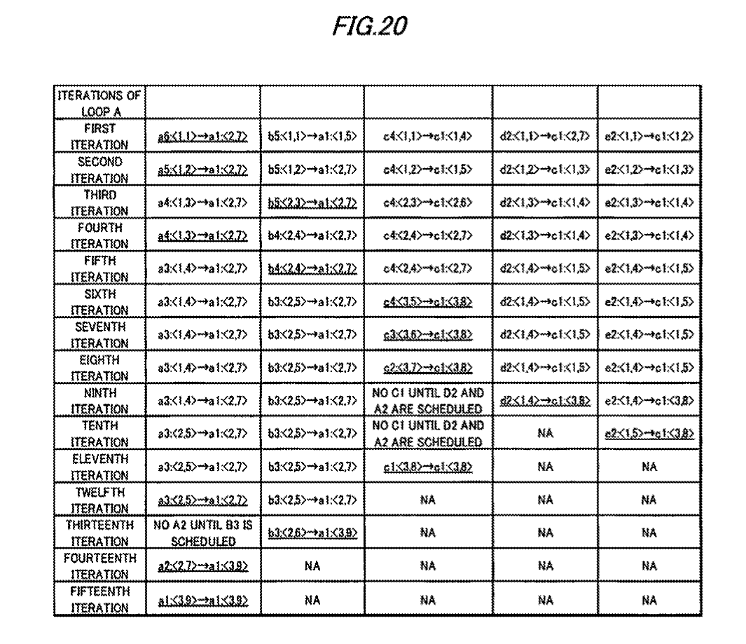

In the following description, the loop consisting of steps S203 to S220 will be referred to as a “loop A.” FIG. 20 shows the result of execution of the loop A. Each row shows an outcome of the loop A. Each column shows outcomes of the loop C on respective instructions included in the set RS. Each cell shows an instruction, a candidate thread number and time to be allocated to, the last instruction in the longest sequence of dependent instructions starting with the instruction, and the predicted execution thread number and time. Scheduling targets selected are shown underlined.

By the second iteration of the loop A, the instruction a5 is scheduled.

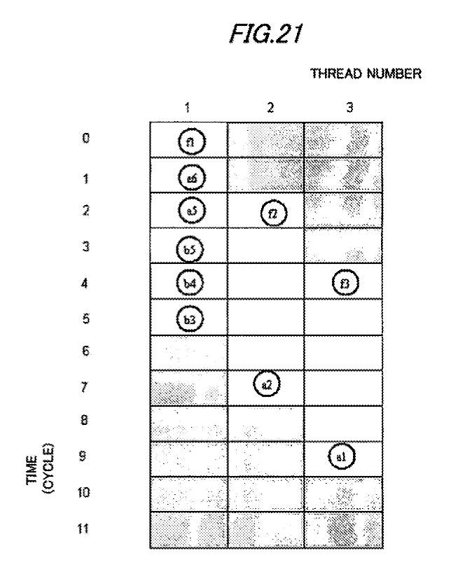

By the third iteration of the loop A, the instruction b5 is scheduled. While the instruction b5 can also be scheduled to thread number 1, time 3, it is thread number 2, time 3 that is selected here by the loop C. The reason lies in the difference in the predicted execution time of the last instruction a1 in the longest sequence of dependent instructions with the instruction b5. When the instruction b5, is scheduled to thread number 1, time 3, the instruction a1 is predicted to be executed at thread number 3, time 9 because of the limitation on the instruction execution start and end times of each thread. FIG. 21 shows the situation. Note that the transmission of data to an adjoining processor entails two cycles of delay.

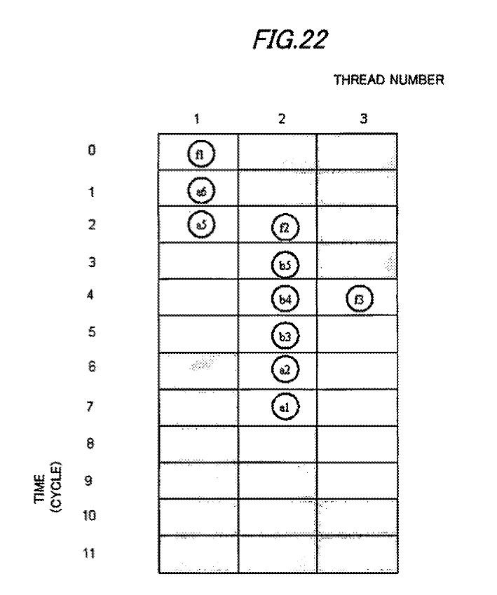

On the other hand, if the instruction b5 is scheduled to thread number 2, time 3, the instruction a1 is predicted to be executed at thread number 2, time 7. FIG. 22 shows the situation.

As seen above, it is possible to analyze a change in the predicted execution time of the last instruction of a longest sequence of dependent instructions depending on the scheduled position of an instruction, taking account of the limitation on the instruction execution start and end times of each thread.

Subsequently, the loop A is repeated to schedule instructions in order of a4, b4, c4, c3, c2, d2, e2, c1, a3, b3, a2, and a1.

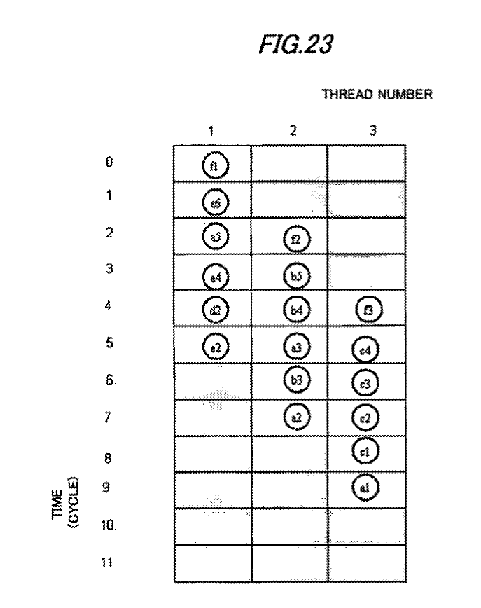

Finally, at step 221, the thread start and end time limitation scheduling part 108 outputs the result of scheduling and ends the processing. FIG. 23 shows the result of scheduling.

As has been described above, according to the concrete example, it is possible to generate a parallelized program of shorter parallel execution time. The reasons will be described below.

A first reason is that it is possible to accurately grasp times available for scheduling in consideration of the limitation on the instruction execution start time of each thread. For example, assuming that the instruction a6 is scheduled to thread number 2 in the first iteration of the loop A, it is shown from the limitation on the instruction execution start time of each thread that the times available for scheduling are at or above time 2.

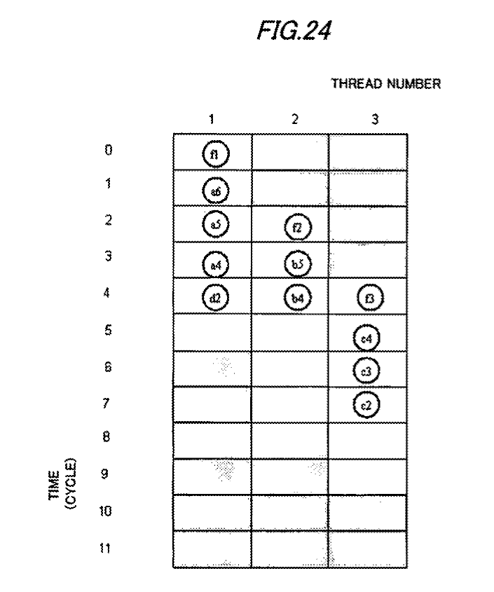

A second reason is that it is possible to predict the thread number and time where each instruction belonging to a longest sequence of dependent instructions starting with a certain instruction will be executed. This allows the accurate prediction of the execution time of the last instruction in a longest sequence of dependent instructions starting with a certain instruction. For example, assume that the instruction d2 is scheduled to thread number 1, time 4 in the ninth iteration of the loop A. Then, let us consider further predicting the thread number and time where the instruction c1 in the longest sequence of dependent instructions d2 and c1 starting with the instruction d2 will be executed. The instruction c1 is dependent on the instruction c2, and the instruction c2 is allocated to thread number 3, time 7. The instruction c1 is therefore predicted to be executed at thread number 3, time 8. FIG. 24 shows the situation.

Since the execution thread number and time are thus predicted for each individual instruction in the longest sequence of dependent instructions, it is possible to accurately predict the execution time of the last instruction in the longest sequence of dependent instructions.

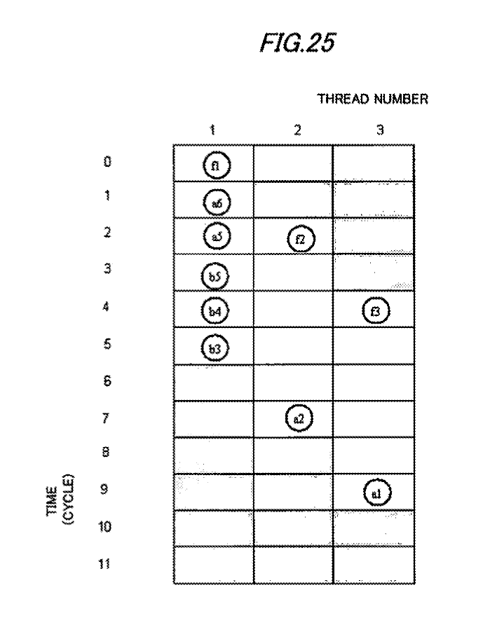

A third reason is that it is possible to predict the execution time of the last instruction in a longest sequence of dependent instructions more accurately since allocatable thread numbers and times can be accurately grasped in consideration of the limitation on the instruction execution end time. For example, assume that the instruction b5 is scheduled to thread number 1, time 3 in the third iteration of the loop A. The instruction b4 is tentatively allocated to time 4, and the instruction b3 to time 5. The instruction a2 is tentatively allocated to thread number 2, time 7 due to the limitation on the instruction execution end time. The last instruction a1 is predicted to be executed at thread 3, time 9 due to the limitation on the instruction execution end time. FIG. 25 shows the situation.

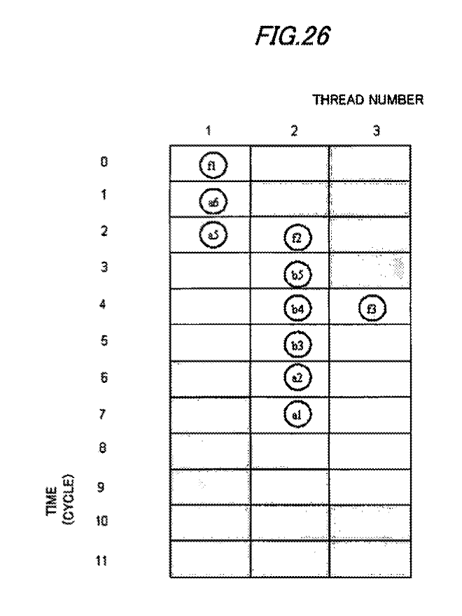

Assuming that the instruction b5 is scheduled to thread number 2, time 3, the instruction a1 is predicted to be executed at thread number 2, time 7. FIG. 26 shows the situation.

In this way, it is possible to predict the execution time of the last instruction in a longest sequence of dependent instruction more accurately in consideration of the limitation on the instruction execution end time.

### Example 2

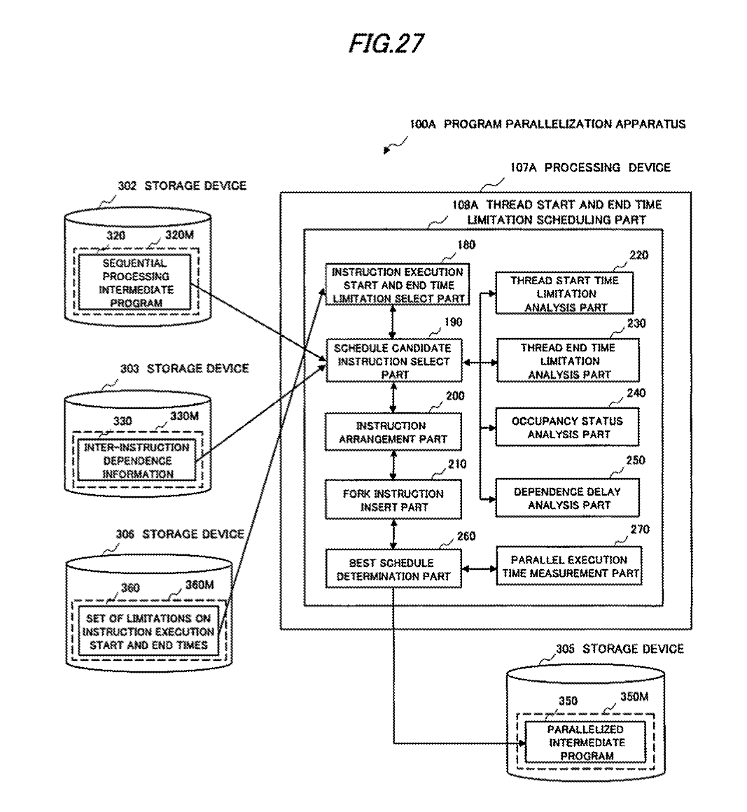

Referring to FIG. 27, a program parallelization apparatus 100A according to a second example of the present invention is an apparatus which inputs a sequential processing intermediate program 320 generated by a not-shown program analysis apparatus from a storing part 320M of a storage device 302, inputs inter-instruction dependence information 330 generated by a not-shown dependence analysis apparatus from a storing part 330M of a storage device 303, inputs a set of limitations 360 on instruction execution start and end times from a storing part 360M of a storage device 306, generates a parallelized intermediate program 350 in which the time and processor to execute each instruction are determined, and records the parallelized intermediate program 350 into a storing part 350M of a storage device 305.

The program parallelization apparatus 100A includes: the storage device 302 such as a magnetic disk which stores the sequential processing intermediate program 320 to be input; the storage device 303 such as a magnetic disk which stores the inter-instruction dependence information 330 to be input; the storage device 306 such as a magnetic disk which stores the set of limitations 360 on the instruction execution start and end times to be input; the storage device 305 such as a magnetic disk which stores the parallelized program 350 to be output; and a processing device 107A such as a central processing unit which is connected with the storage devices 302, 303, 305, and 306. The processing device 107A includes a thread start and end time limitation scheduling part 108A.

Such a program parallelization apparatus 100A can be implemented by a computer such as a personal computer and a workstation, and a program. The program is recorded on a computer-readable recording medium such as a magnetic disk, is read by the computer on such an occasion as startup of the computer, and controls the operation of the computer, thereby implementing the functional units such as the thread start and end time limitation scheduling part 108A on the computer.

The thread start and end time limitation scheduling part 108A performs instruction scheduling on a plurality of elements of a set of limitations on the instruction execution start and end times of each thread, and determines an instruction schedule of shortest parallel execution time. The instruction scheduling specifically refers to determining the execution thread number and execution time of each instruction. The thread start and end time limitation scheduling part 108A then determines the order of execution of instructions so as to carry out the determined schedule, and inserts fork instructions. The thread start and end time limitation scheduling part 108A then records the parallelized intermediate program 350, the result of parallelization.

The thread start and end time limitation scheduling part 108A includes: an instruction execution start and end time limitation select part 180 which selects a limitation on the instruction execution start and end times of each thread; a thread start time limitation analysis part 220 which analyzes an instruction-allocatable time based on the limitation on the instruction execution start time of each thread; a thread end time limitation analysis part 230 which analyzes an instruction-allocatable time based on the limitation on the instruction execution end time of each thread; an occupancy status analysis part 240 which analyzes thread numbers and time slots that are occupied by already-scheduled instructions; a dependence delay analysis part 250 which analyzes an instruction-allocatable time based on a delay resulting from dependence between instructions; a schedule candidate instruction select part 190 which selects the next instruction to schedule based on the information on the thread start time limitation analysis part 220, the thread end time limitation analysis part 230, the occupancy status analysis part 240, and the dependence delay analysis part 250; an instruction arrangement part 200 which allocates instructions to slots, i.e., determines the execution times and execution threads of the instructions based on the determination of the schedule candidate instruction select part 190; a fork insert part 210 which determines the order of execution of instructions so as to carry out the determined schedule, and inserts fork instructions; a parallel execution time measurement part 270 which measures or predicts the parallel execution time of a result of scheduling; and a best schedule determination part 260 which changes the limitation on the instruction execution start and end times of each thread, compares the respective results of scheduling, and selects a best one.

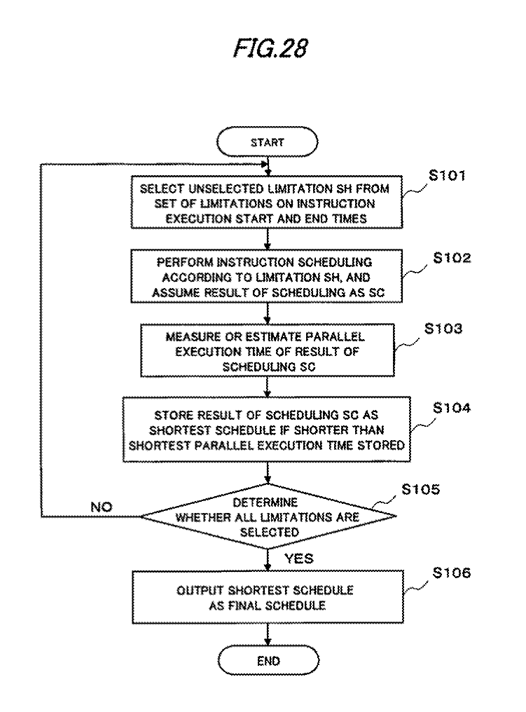

Next, the operation of the program parallelization apparatus 100A according to the present example will be described. In particular, the scheduling processing to be processed by the thread start and end time limitation scheduling part 108A with a limitation imposed on the instruction execution start and end times of each thread will be described with reference to FIG. 28.

The thread start and end time limitation scheduling part 108A inputs the sequential processing intermediate program 320 from the storing part 320M of the storage device 302. The sequential processing intermediate program 320 is expressed in the form of a graph. Functions that constitute the sequential processing intermediate program 320 are expressed by nodes that represent the functions. Instructions that constitute the functions are expressed by nodes that represent the instructions. Loops may be converted into recursive functions and expressed as recursive functions. In the sequential processing intermediate program 320, there is defined a schedule area to be subjected to the instruction scheduling of determining the execution times and execution thread numbers of instructions. The schedule area, for example, may consist of a basic block or a plurality of basic blocks.

Next, the thread start and end time limitation scheduling part 108A inputs the inter-instruction dependence information 330 from the storing part 330M of the storage device 303. The dependence information 330 shows dependence between instructions which is obtained by the analysis of data flows and control flows associated with register and memory read and write. The dependence information 330 is expressed by directed links which connect nodes that represent instructions.

The thread start and end time limitation scheduling part 108A then inputs a set of limitations 360 on the instruction execution start and end times of each thread from the storing part 360M of the storage device 306.

For example, each individual limitation may be such that a difference between the start time and end time is constant in all threads and the start time increases with the thread number by a constant increment. A concrete example will be given with reference to FIG. 8.

In FIG. 8, each cell shows a thread number and a time slot. The colored cells indicate that instructions are assigned thereto. The coloring is intended to make a distinction between a plurality of threads running on the same processor. A limitation that the interval is one cycle and the number of instructions is four is that of instruction arrangement such as shown in FIG. 8A. A limitation that the interval is two cycles and the number of instructions is eight is that of instruction arrangement such as shown in FIG. 8B. A limitation may be employed such that the start time of each thread increases with the thread number by a constant increment but the number of instructions in each thread is not limited. A limitation may be employed such that only the number of instructions in each thread is limited but not the start time of each thread.

A limitation such that a difference between the start time and end time is constant in all threads and the start time increases with the thread number by a constant increment will be expressed by <the increment of the start time, a difference between the start time and end time>. The number of processors will be denoted by NPE, and the delay time of a fork instruction by Lfork. For example, a set of limitations may include <Lfork,Lfork×NPE>, <Lfork+1,(Lfork+1)×NPE>, <Lfork+2,(Lfork+2)×NPE>, . . . . A limitation may be further added such that the start time of each thread increases with the thread number by a constant increment but the number of instructions in each thread is not limited.

Initially, the thread start and end time limitation scheduling part 108A selects an unselected limitation SH from the set of limitations on the instruction execution start and end times of each thread (step S101).

Next, the thread start and end time limitation scheduling part 108A performs instruction scheduling according to the limitation SH. The result of scheduling will be denoted by SC (step S102). This step is the same as shown in FIGS. 2 to 5 of the first example.

Next, the thread start and end time limitation scheduling part 108A measures or estimates the parallel execution time of the result of scheduling SC (step S103). For example, the parallel execution time may be determined by recording the positions of already-schedule instructions into a two-dimensional table of thread numbers and times and consulting the table. The parallel execution time may be estimated by simulation, for example. Object code that implements the result of scheduling SC may be generated and executed for measurement.

Next, the thread start and end time limitation scheduling part 108A stores the result of scheduling SC as a shortest schedule if it is shorter than shortest parallel execution time stored (step S104).

Next, the thread start and end time limitation scheduling part 108A determines whether all the limitations are selected (step S105). If all the limitations are not selected, the thread start and end time limitation scheduling part 108A returns the control to S101.

If all the limitations are selected, the thread start and end time limitation scheduling part 108A outputs the shortest schedule as the final schedule, and ends the processing (step S106).

Next, the effect of the second example will be described.

According to the second example, it is possible to generate a parallelized program having parallel execution time shorter than in the first example. The reason is that it is possible to select a preferred limitation from among a plurality of limitations on the instruction execution start and end times of each thread, and determines the schedule based on the limitation.

### Example 3

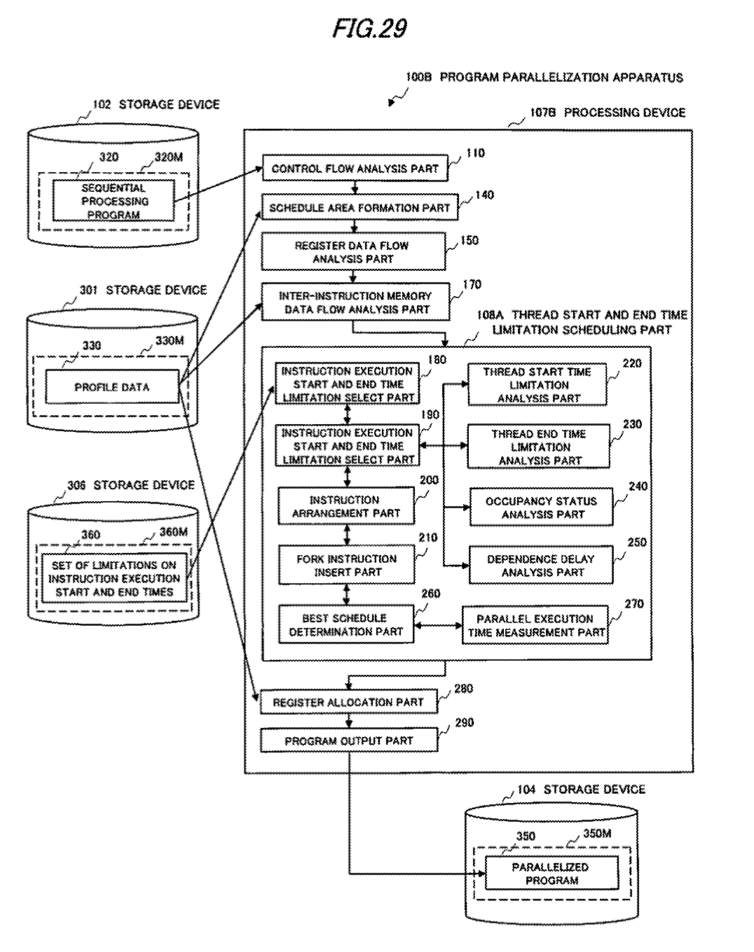

Referring to FIG. 29, a program parallelization apparatus 100A is an apparatus which inputs a sequential processing program 101 of machine language instruction form generated by a not-shown sequential complier, and generates and outputs a parallelized program 103 intended for multithreaded parallel processors.

The program parallelization apparatus 100B includes: a storage device 102 such as a magnetic disk which stores the sequential processing program 101 to be input; a storage device 306 such as a magnetic disk which contains a set of limitations 360 on the instruction execution start and end times to be input; a storage device 104 such as a magnetic disk which stores the parallelized program 103 to be output; a storage device 301 such as a magnetic disk which contains profile data for use in the process of conversion of the sequential processing program 101 into the parallelized program 103; and a processing device 107B such as a central processing unit which is connected with the storage devices 102, 104, 301, and 306. The processing device 107B includes a control flow analysis part 110, a schedule area formation part 140, a register data flow analysis part 150, an inter-instruction memory data flow analysis part 170, a thread start and end time limitation scheduling part 108A, a register allocation part 280, and a program output part 290.

Such a program parallelization apparatus 100B can be implemented by a computer such as a personal computer and a workstation, and a program. The program is recorded on a computer-readable recording medium such as a magnetic disk, is read by the computer on such an occasion as startup of the computer, and controls the operation of the computer, thereby implementing the functional units such as the control flow analysis part 110, the schedule area formation part 140, the register data flow analysis part 150, the inter-instruction memory data flow analysis part 170, the thread start and end time limitation scheduling part 108A, the register allocation part 280, and the program output part 290 on the computer.

The control flow analysis part 110 inputs the sequential processing program 101 from a storing part 101M of the storage device 102, and analyzes the control flow. With reference to the result of analysis, loops may be converted into recursive functions. The iterations of the loops can be parallelized by such conversion.

The schedule area formation part 140 refers to the result of analysis of the control flow by the control flow analysis part 110 and profile data 310 input from a storing part 310M of the storage device 301, and determines a schedule area to be subjected to the instruction scheduling of determining the execution times and execution thread numbers of instructions.

The register data, flow analysis part 150 refers to the result of analysis of the control flow by the control flow analysis part 110 and the determination of the schedule area made by the schedule area formation part 140, and analyzes a data flow that is associated with register read and write.

The inter-instruction memory data flow analysis part 170 refers to the result of analysis of the control flow by the control flow analysis part 110 and the profile data 310 input from the storing part 310M of the storage device 301, and analyzes a data flow that is associated with read and write to a certain memory address.

The thread start and end time limitation scheduling part 108A performs instruction scheduling with a plurality of elements of a set of limitations on the instruction execution start and end times of each thread, and determines an instruction schedule of shortest parallel execution time. The instruction scheduling specifically refers to determining the execution thread number and execution time of each instruction. In the process, the thread start and end time limitation scheduling part 108A refers to the result of analysis of the register data flow by the register data flow analysis part 150 and the result of analysis of data flow between instructions obtained by the inter-instruction memory data flow analysis part 170. The thread start and end time limitation scheduling part 108A then determines the order of execution of instructions so as to carry out the determined schedule, and inserts fork instructions.

The register allocation part 280 refers to the order of execution of instructions determined by the thread start and end time limitation scheduling part 108A and the fork instructions, and performs register allocation.

The program output part 290 refers to the result of the register allocation part 280, and generates and outputs an executable program.

The thread start and end time limitation scheduling part 108A includes: an instruction execution start and end time limitation select part 180 which selects a limitation on the instruction execution start and end times of each thread; a thread start time limitation analysis part 220 which analyzes an instruction-allocatable time based on the limitation on the instruction execution start time of each thread; a thread end time limitation analysis part 230 which analyzes an instruction-allocatable time based on the limitation on the instruction execution end time of each thread; an occupancy status analysis part 240 which analyzes thread numbers and time slots that are occupied by already-scheduled instructions; a dependence delay analysis part 250 which analyzes an instruction-allocatable time based on a delay resulting from dependence between instructions; a schedule candidate instruction select part 190 which selects the next instruction to schedule based on the information on the thread start time limitation analysis part 220, the thread end time limitation analysis part 230, the occupancy status analysis part 240, and the dependence delay analysis part 250; an instruction arrangement part 200 which allocates instructions to slots, i.e., determines the execution times and execution threads of the instructions based on the determination of the schedule candidate instruction select part 190; a fork insert part 210 which determines the order of execution of instructions so as to carry out the determined schedule, and inserts fork instructions; a parallel execution time measurement part 270 which measures or predicts the parallel execution time of a result of scheduling; and a best schedule determination part 260 which changes the limitation on the instruction execution start and end times of each thread, compares the respective results of scheduling, and selects a best one.

Next, the operation of the program parallelization apparatus 100B according to the present example will be described.

Initially, the control flow analysis part 110 inputs the sequential processing program 101 from the storing part 101M of the storage device 102, and analyzes the control flow. In the program parallelization apparatus, the sequential processing program 101 is expressed in the form of a graph. Functions that constitute the sequential processing program 101 are expressed by nodes that represent the functions. Instructions that constitute the functions are expressed by nodes that represent the instructions.

The schedule area formation part 140 refers to the result of analysis of the control flow by the control flow analysis part 110 and the profile data 310 input from the storing part 310M of the storage device 301, and determines the schedule area to be subjected to the instruction scheduling of determining the execution times and execution threads of the instructions. The schedule area, for example, may consist of a basic block or a plurality of basic blocks.

The register data flow analysis part 150 refers to the result of analysis of the control flow by the control flow analysis part 110 and the determination of the schedule area made by the schedule area formation part 140, and analyzes a data flow that is associated with register read and write. For example, the data flow may be analyzed either within each function or across functions. The dependence of the data flow between instructions will be expressed by directed allows which connect nodes that represent the instructions.

The inter-instruction memory data flow analysis part 170 refers to the result of analysis of the control flow by the control flow analysis part 110 and the profile data 310 input from the storing part 310M of the storage device 301, and analyzes a data flow that is associated with read and write to a certain memory address. The dependence of the data flow between instructions will be represented by directed allows which connect nodes that represent the instructions.

The thread start and end time limitation scheduling part 108A performs instruction scheduling on a plurality of elements of a set of limitations on the instruction execution start and end times of each thread, and determines an instruction schedule of shortest parallel execution time. The instruction scheduling specifically refers to determining the execution time and execution thread number of each instruction. In the process of instruction scheduling, the thread start and end time limitation scheduling part 108A refers to the result of analysis of the register data flow by the register data flow analysis part 150 and the result of analysis of the dependence between instructions obtained by the inter-instruction memory data flow analysis part 170. The thread start and end time limitation scheduling part 108A then determines the order of execution of instructions so as to carry out the determined schedule, and inserts fork instructions.

The register allocation part 280 refers to the order of execution of instructions determined by the thread start and end time limitation scheduling part 108A and the fork instructions, and performs register allocation.

The program output part 290 refers to the result of the register allocation part 280, and generates and outputs an executable program.

The scheduling processing to be processed by the thread start and end time limitation scheduling part 108A with a limitation imposed on the instruction execution start and end times of each thread is the same as in the second example. Description thereof will thus be omitted.

Next, the effects of the present example will be described.

According to the present example, it is possible to generate a parallelized program of shorter parallel execution time. The reasons will be described below.

A first reason is that the reduction of idle time where no instruction is executed in each thread and equal numbers of instructions to execute in respective threads can reduce cycles where the processors execute no instruction. This will be described in conjunction with the example of FIG. 6. In FIG. 6A, so many instructions are allocated to thread 1 that the processor 2 undergoes cycles where no instruction is executed. According to the present example, it is possible to allocate equal numbers of instructions as shown in FIG. 6B. This can reduce the cycles where no instruction is executed in the processor 2, with a reduction in parallel execution time.

A second reason is that the reduction of idle time where no instruction is executed in each thread and the uniform intervals between the execution start times in the threads can reduce cycles where the processors execute no instruction. This will be described in conjunction with the example of FIG. 7. In FIG. 7A, the processor 1 undergoes a cycle where no instruction is executed since the sequence of instructions allocated to thread 2 has a late start time. According to the present example, it is possible to allocate instructions with uniform intervals between the instruction execution start times as shown in FIG. 7B. This can reduce the cycle where no instruction is executed in the processor 1, with a reduction in parallel execution time.

In order to reduce idle time where no execution is executed in each thread, make the numbers of instructions to execute in respective threads uniform, and make the intervals between the execution start times of the respective threads uniform, it is needed to perform scheduling so as to reduce parallel execution time with a limitation imposed on the instruction execution start and end times of each thread. In order to reduce the parallel execution time of an instruction schedule, it is needed to predict the execution completion times of the last instructions in longest sequences of dependent instructions starting with respective unscheduled instructions, and schedule the first instruction of the latest time first. The reason is that if the scheduling of the first instruction in the sequence of instructions that completes its execution the latest is postponed, the execution completion time of the sequence of instructions can possibly be even greater. It is therefore needed to improve the prediction accuracy to predict the execution completion time of a sequence of instructions. For such a purpose, it is needed to accurately grasp thread numbers and times to which the first instruction can be scheduled, and accurately predict the execution time of the sequence of instructions. According to the present example, the foregoing are made possible with a limitation imposed on the execution start and end times of the instructions in each thread. As a result, it is possible to reduce idle time where no instruction is executed in each thread, make the numbers of instructions to execute in the respective threads uniform, and make the intervals between the execution start times in the threads uniform.

The reason why it is possible to accurately grasp thread numbers and times to which the first instruction in a sequence of instructions on a dependence graph starting with the instruction can be scheduled is that the instruction-allocatable thread numbers and times can be selected in consideration of the limitation on the instruction execution start and end times of each thread.

The execution time of the last instruction in a longest sequence of dependent instructions starting with a certain instruction can be accurately predicted for the reasons that: it is possible to predict the thread number and time to execute each instruction belonging to the longest sequence of dependent instructions; and it is possible to predict the execution time of the sequence of instructions in consideration of the limitation on the instruction execution start and end times of each thread.

### Other Examples

Up to this point, the exemplary embodiments and examples of the present invention have been described. However, the present invention is not limited only to the foregoing exemplary embodiments and examples, and various other additions and modification may be made thereto. For example, in each of the foregoing examples, the profile data 310 may be omitted.

It should be noted that the foregoing program parallelization apparatuses are not limited to any particular physical configuration, hardware (analog circuit, digital circuit) configuration, or software (program) configuration as long as the processing (functions) of the foregoing parts (units) constituting the respective components can be implemented. The apparatus may be provided in any mode. For example, respective independent circuits, units, or program parts (program modules) may be configured. The circuitry may be integrally configured in a single circuit or unit. Such modes may be selected as appropriate depending on the circumstances, including the function and application of the apparatus in actual use. An operation method (program parallelization method) having corresponding steps for performing the same processing as the processing (functions) of the foregoing components is also embraced in the scope of the present invention.

When the functions of the foregoing parts (units) are implemented at least in part by software processing of a computer such as a CPU (Central Processing Unit) or an MPU (Micro Processing Unit), the program to be executed by the computer is also embraced in the scope of the present invention. Such a program is not limited to a form of program that is directly executable by the CPU, and may include various forms of programs such as a program in source form, a compressed program, and an encrypted program. The program may be applied in any mode, including an application program that runs in cooperation with control programs such as an OS (Operating System) and firmware for controlling the entire apparatus, an application program that is incorporated in and makes an integral operation with the control programs, and software parts (software modules) that constitute such an application program. If the program is mounted and used on an apparatus that has communication capabilities to communicate with an external device through a wireless or wired line, the program may be downloaded from a server device or other external node online, and installed in a recording medium of the own apparatus for use. Such modes may be selected as appropriate depending on the circumstances, including the function and application of the apparatus in actual use.

A computer-readable recording medium containing the foregoing computer program is also embraced in the scope of the present invention. In such a case, any mode of recording medium may be used, including memories such as ROM (Read Only Memory), ones fixed in the apparatus for use, and portable types that can be carried by users.

Although the exemplary embodiments of the present invention have been described in detail, it should be understood that various changes, substitutions and alternatives can be made therein without departing from the spirit and scope of the invention as defined by the appended claims. Further, it is the inventor's intent to retain all equivalents of the claimed invention even if the claims are amended during prosecution.

This application is based upon and claims the benefit of priority from Japanese Patent Application No. 2008-034614, filed on Feb. 15, 2008, the disclosure of which is incorporated herein in its entirety by reference.

### INDUSTRIAL APPLICABILITY

As has been described above, the present invention may be applied to a program parallelization apparatus, a program parallelization method, and a program parallelization program which generate a parallelized program intended for multithreaded parallel processors from a sequential processing program.

1. A program parallelization apparatus for inputting a sequential processing intermediate program and outputting a parallelized intermediate program, said apparatus comprising:
a thread start time limitation analysis part that analyzes an instruction-allocatable time based on a limitation on an instruction execution start time of each thread;
a thread end time limitation analysis part that analyzes an instruction-allocatable time based on a limitation on an instruction execution end time of each thread;
an occupancy status analysis part that analyzes a time not occupied by an already-scheduled instruction;
a dependence delay analysis part that analyzes an is instruction-allocatable time based on a delay resulting from dependence between instructions;
a schedule candidate instruction select part that selects a next instruction to schedule; and
an instruction arrangement part that allocates a processor and time to execute to an instruction.

2. A program parallelization apparatus for inputting a sequential processing intermediate program and outputting a parallelized intermediate program, said apparatus comprising:
an instruction execution start and end time limitation select part that selects a limitation from a set of limitations on instruction execution start and end times of each thread;
a thread start time limitation analysis part that analyzes an instruction-allocatable time based on the limitation on the instruction execution start time of each thread;
a thread end time limitation analysis part that analyzes an instruction-allocatable time based on the limitation on the instruction execution end time of each thread;
an occupancy status analysis part that analyzes a time not occupied by an already-scheduled instruction;
a dependence delay analysis part that analyzes an instruction-allocatable time based on a delay resulting from dependence between instructions;
a schedule candidate instruction select part that selects a next instruction to schedule;
an instruction arrangement part that allocates a processor and time to execute to an instruction;
a parallel execution time measurement part that measures or estimates parallel execution time in response to a result of scheduling; and
a best schedule determination part that changes the limitation and repeats scheduling to determine a best schedule.

3. A program parallelization apparatus for inputting a sequential processing program and outputting a parallelized program intended for multithreaded parallel processors, said apparatus comprising:
a control flow analysis part that analyzes a control flow of the input sequential processing program;
a schedule area formation part that refers to a result of analysis of the control flow by the control flow analysis part and determines an area to be scheduled;
a register data flow analysis part that refers to a determination of a schedule area made by the schedule area formation part and analyzes a data flow of a register;
an inter-instruction memory data flow analysis part that analyzes dependence between an instruction to make a read or write to an address and an instruction to make a read or write from the address;
an instruction execution start and end time limitation select part that selects a limitation from a set of limitations on an interval between instruction execution start times of respective threads and the number of instructions to be executed;
a thread start time limitation analysis part that analyzes an instruction-allocatable time based on the limitation on the instruction execution start time of each thread;
a thread end time limitation analysis part that analyzes an instruction-allocatable time based on a limitation on an instruction execution end time of each thread;
an occupancy status analysis part that analyzes a time not occupied by an already-scheduled instruction;
a dependence delay analysis part that analyzes an instruction-allocatable time based on a delay resulting from dependence between instructions;
a schedule candidate instruction select part that selects a next instruction to schedule;
an instruction arrangement part that allocates a processor and time to execute to an instruction;
a parallel execution time measurement part that measures or estimates parallel execution time in response to a result of scheduling;
a best schedule determination part that changes the limitation and repeats scheduling to determine a best schedule;
a register allocation part that refers to a result of determination of the best schedule and performs register allocation; and
a program output part that refers to a result of the register allocation, and generates and outputs the parallelized program.

4. The program parallelization apparatus according to claim 1, wherein the schedule candidate instruction select part analyzes a thread number and time to execute each of instructions that belong to a sequence of dependent instructions starting with a candidate instruction to schedule.

5. (canceled)

6. A program parallelization method for inputting a sequential processing intermediate program and outputting a parallelized intermediate program intended for multithreaded parallel processors, said method comprising the steps of:
selecting a limitation from a set of limitations on instruction execution start and end times of each thread;
for an instruction, analyzing an instruction-allocatable time based on the limitation on the instruction execution start time of each thread;
for an instruction, analyzing an instruction-allocatable time based on the limitation on the instruction execution end time of each thread;
analyzing a time not occupied by an already-scheduled instruction processor by processor;
analyzing a delay resulting from dependence between instructions;
selecting a next instruction to schedule; and
allocating a processor and time to execute to an instruction.

7. A program parallelization method for inputting a sequential processing intermediate program and outputting a parallelized intermediate program, said method comprising the steps of:
selecting a limitation from a set of limitations on an interval between instruction execution start times of respective threads and the number of instructions to be executed;
analyzing an instruction-allocatable time based on the limitation on the instruction execution start time of each thread;
analyzing an instruction-allocatable time based on a limitation on an instruction execution end time of each thread;
analyzing a time not occupied by an already-scheduled instruction processor by processor;
analyzing a delay resulting from dependence between instructions;
selecting a next instruction to schedule;
allocating a processor and time to execute to an instruction;
measuring or estimating parallel execution time in response to a result of scheduling; and
changing the limitation and repeating scheduling to determine a best schedule.

8. A program parallelization method for inputting a sequential processing program and outputting a parallelized program intended for multithreaded parallel processors, said method comprising the steps of:
analyzing a control flow of the input sequential processing program;
referring to a result of analysis of the control flow and determining an area to be scheduled;
referring to a determination of a schedule area and analyzing a data flow of a register;
analyzing dependence between an instruction to make a read or write to an address and an instruction to make a read or write from the address;
selecting a limitation from a set of limitations on instruction execution start and end times of each thread;
analyzing an instruction-allocatable time based on the limitation on the instruction execution start time of each thread;
analyzing an instruction-allocatable time based on the limitation on the instruction execution end time of each thread;
analyzing a time not occupied by an already-scheduled instruction processor by processor;
analyzing a delay resulting from dependence between instructions;
selecting a next instruction to schedule;
allocating a processor and time to execute to an instruction;
measuring or estimating parallel execution time in response to a result of scheduling;
changing the limitation and repeating scheduling to determine a best schedule;
referring to a result of determination of the best schedule and performing register allocation; and
referring to a result of the register allocation, and generating and outputting the parallelized program.

9. The program parallelization method according to claim 6, comprising the steps in which:
a) an instruction execution start and end time limitation select part selects an unselected limitation SH from a set of limitations on the instruction execution start and end times of each thread;
b) a thread start time limitation analysis part, a thread end time limitation analysis part, an occupancy status analysis part, a dependence delay analysis part, a schedule candidate instruction select part, and an instruction arrangement part perform instruction scheduling according to the limitation SH, and obtain a result of scheduling SC;
c) a parallel execution time measurement part measures or estimates parallel execution time of the result of scheduling SC;
d) a best schedule determination part stores the result of scheduling SC as a shortest schedule if it is shorter than shortest parallel execution time stored;
e) the best schedule determination part determines whether all the limitations are selected; and
f) the best schedule determination part outputs the shortest schedule as a final schedule.

10. The program parallelization method according to claim 9, wherein the step b) includes the steps in which:
b-1) the instruction arrangement part calculates HT(I) for each instruction I, and stores the instruction that gives the value;
b-2) the instruction arrangement part registers an instruction on which no instruction is dependent into a set RS;
b-3) the instruction arrangement part deselects all instructions in the set RS;
b-4) the schedule candidate instruction select part selects an unselected instruction belonging to the set RS as an instruction RI;
b-5) the schedule candidate instruction select part determines a highest thread number LF among those of already-scheduled instructions on which the instruction RI is dependent, determines a lowest thread number RM that is higher than the thread number LF and to which no instruction is currently allocated, and sets a thread number TN to the LF;
b-6) for a thread of the thread number TN, the thread start time limitation analysis part analyzes a minimum value of the instruction-allocatable time based on the limitation on the instruction execution start time of each thread, and assumes the time as ER1;
b-7) for the thread of the thread number TN, the occupancy status analysis part analyzes times where are not occupied by already-scheduled instructions, and assumes a set of the times as ER2;
b-8) the dependence delay analysis part determines a time of arrival ER3 of data from an instruction that delivers data to the thread of the thread number TN the latest among already-scheduled instructions on which the instruction RI is dependent;
b-9) for the thread of the thread number TN, the thread end time limitation analysis part analyzes a maximum value of the instruction-allocatable time based on the limitation on the instruction execution end time, and assumes the value as ER4;
b-10) the schedule candidate instruction select part determines whether there is a minimum element of the set ER2 that is at or above the time ER1, at or below the time ER4, and at or above the time ER3;
b-11) the schedule candidate instruction select part advances the thread number TN by one;
b-12) the schedule candidate instruction select part assumes the time as ER5 if exists;
b-13) the schedule candidate instruction select part estimates an execution time of a last instruction TI in a longest sequence of dependent instructions starting with the instruction RI based on the limitation on the execution start and end times of each thread, on the assumption that the instruction RI is tentatively allocated to the thread number TN and the time ER5;
b-14) the schedule candidate instruction select part stores the thread number and time of the instruction RI with which the instruction TI is executed at an earliest time across the thread number TN, and an estimated predicted time of the instruction TI into the instruction RI;
b-15) the schedule candidate instruction select part determines whether the thread number TN reaches RM;
b-16) the schedule candidate instruction select part advances the thread number TN by one;
b-17) the schedule candidate instruction select part determines whether all the instructions in the set RS are selected;
b-18) the instruction arrangement part assumes an instruction that provides the maximum predicted time of the instruction TI stored at the step b-14 as a scheduling target CD, and allocates the scheduling target CD to the thread number stored at the step b-14 and the time stored at the step b-14;
b-19) the instruction arrangement part removes the instruction CD from the set RS, checks the set RS for an instruction that is dependent on the instruction CD, assume that the dependence of the instruction on the instruction CD is resolved, and if the instruction has no other instruction to depend on, register the instruction into the set RS;
b-20) the instruction arrangement part determines whether all the instructions are scheduled; and
b-21) the instruction arrangement part outputs the result of scheduling.

11. The program parallelization method according to claim 10, wherein the step b-9) includes the steps in which:
b-9-1) the schedule candidate instruction select part determines a longest sequence of instructions TS starting with the instruction RI on a dependence graph, and expresses the sequence of instructions TS as TL[0], TL[1], TL[2], . . . , where TL[0] is RI;
b-9-2) the schedule candidate instruction select part sets a variable V2 to 1;
b-9-3) the schedule candidate instruction select part determines a highest thread number LF2 among those of already-scheduled or tentatively-allocated instructions on which the instruction TL[V2] is dependent, determines a lowest thread number RM2 that is higher than the thread number LF2 and to which no instruction is currently allocated, and substitutes LF2 into a variable CU;
b-9-4) for a thread of the thread number CU, the thread start time limitation analysis part analyzes a minimum value of the instruction-allocatable time based on the limitation on the instruction execution start time of each thread, and assumes the time as ER11;
b-9-5) for the thread of the thread number CU, the occupancy status analysis part analyzes times that are not occupied by already-scheduled or tentatively-allocated instructions, and assumes a set of the times as ER12;
b-9-6) the dependence delay analysis part checks already-scheduled or tentatively-allocated instructions on which the instruction TL[V2] is dependent for transmission of data to the instruction TL[V2], checks the times of arrival of the data from such instructions to the thread of the thread number CU, and assumes a maximum value thereof as ER13;
b-9-7) for the thread of the thread number CU, the thread end time limitation analysis part analyzes a maximum value of the instruction-allocatable time based on the limitation on the instruction execution end time, and assumes the value as ER14;
b-9-8) the schedule candidate instruction select part determines whether there is a minimum element of the set ER12 that is at or above the time ER11, at or below the time ER14, and at or above the time ER13;
b-9-9) the schedule candidate instruction select part advances the thread number CU by one;
b-9-10) the schedule candidate instruction select part assumes the time as ER15 if exists;
b-9-11) the schedule candidate instruction select part stores a minimum value of the time ER15 of the instruction TL[V2] across the thread number CU, and if the minimum value is updated, stores the thread number CU as well;
b-9-12) the schedule candidate instruction select part determines whether the thread number CU reaches RM2;
b-9-13) the schedule candidate instruction select part increases the thread number CU by one;
b-9-14) the schedule candidate instruction select part tentatively allocates the instruction TL[V2] to the thread number and time stored at the step b-9-11;
b-9-15) the schedule candidate instruction select part determines whether all the instructions in the sequence of instructions TS are tentatively allocated;
b-9-16) the schedule candidate instruction select part increases the variable V2 by one; and
b-9-17) the schedule candidate instruction select part detaches all tentative allocations, and outputs the thread number and time to which the instruction TL[V2] is tentatively allocated.

12. The program parallelization method according to claim 6, wherein the step of selecting a next instruction to schedule includes analyzing a thread number and time to execute each of instructions that belong to a longest sequence of dependent instructions starting with a candidate instruction to schedule.

13. The program parallelization method according to claim 6, wherein in the step of selecting a limitation from the set of limitations on the instruction execution start and end times of each thread, the set of limitations includes only limitations on the execution start and end times such that a difference between the start time and end time is constant in all threads and the start time increases with the thread number by a constant increment.

14. A computer-readable medium stored therein a program parallelization program for use with a computer that constitutes a program parallelization apparatus for inputting a sequential processing intermediate program and outputting a parallelized intermediate program intended for multithreaded parallel processors, said program parallelization program making the computer function as:
an instruction execution start and end time limitation select unit that selects a limitation from a set of limitations on an interval between instruction execution start times of respective threads and the number of instructions to be executed;
a thread start time limitation analysis unit that analyzes an instruction-allocatable time based on the limitation on the instruction execution start time of each thread;
a thread end time limitation analysis unit that estimates an instruction to be executed at a latest time in a sequence of dependent instructions to which a certain instruction belongs and an execution time of the latest instruction based on the limitation on the number of instructions to execute in each thread;
an occupancy status analysis unit that analyzes a time not occupied by an already-scheduled instruction processor by processor;
a dependence delay analysis unit that analyzes an instruction-allocatable time based on a delay resulting from dependence between instructions;
a schedule candidate instruction select unit that selects a next instruction to schedule; and
an instruction arrangement unit that allocates a processor and time to execute to an instruction.

15. (canceled)

16. (canceled)

17. The computer-readable medium according to claim 14, wherein the schedule candidate instruction select unit analyzes a thread number and time to execute each of instructions that belong to a longest sequence of dependent instructions starting with a candidate instruction to schedule.

18. The computer-readable medium according to claim 14, wherein the instruction execution start and end time limitation select unit includes in the set of limitations only limitations on the execution start and end times such that a difference between the start time and end time is constant in all threads and the start time increases with the thread number by a constant increment.
